(19) United States
(12) Patent Application Publication
(10) Pub. No.: US 2011/0019239 A1
(43) Pub. Date: Jan. 27, 2011

(54) Image Reproducing Apparatus And Image Sensing Apparatus

(75) Inventors: Kazuhiro KOJIMA, Higashiosaka City (JP); Yukio MORI, Hirakata City (JP); Yasuhachi HAMAMOTO, Higashiosaka City (JP); Kanichi KOYAMA, Higashiosaka City (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/844,386

(22) Filed: Jul. 27, 2010

(30) Foreign Application Priority Data
Jul. 27, 2009 (JP) 2009-174006
Jun. 8, 2010 (JP) 2010-130763

(51) Int. Cl. H04N 1/00

(52) U.S. Cl. 358/401

(57) ABSTRACT

Provided is an image reproducing apparatus including a touch panel monitor which has a display screen and receives touch panel operation performed with an operation member touching the display screen, in which an output image obtained by extracting an image inside an extraction region as a part of an entire image area of an input image from the input image is displayed on the touch panel monitor or a monitor of an external display device. The touch panel monitor receives region specifying operation of specifying a position and a size of the extraction region as one type of the touch panel operation when an entire image of the input image is displayed on the display screen. In the region specifying operation, the position and the size of the extraction region are specified on the basis of a position at which the operation member touches the display screen and a period of time while the operation member is touching the display screen, or on the basis of an initial point and a terminal point of a movement locus of the operation member on the display screen, or on the basis of a plurality of positions at which the a plurality of operation members as the operation member touch the display screen.

### CROSS-REFERENCE TO RELATED APPLICATIONS

This nonprovisional application claims priority under 35 U.S.C. §119(a) on Patent Application No. 2009-174006 filed in Japan on Jul. 27, 2009 and on Patent Application No. 2010-130763 filed in Japan on Jun. 8, 2010, the entire contents of which are hereby incorporated by reference.

### BACKGROUND OF THE INVENTION

1. Field of the Invention

The present invention relates to an image reproducing apparatus which performs reproduction of images and an image sensing apparatus which obtains images by photography.

2. Description of Related Art

In a conventional image reproducing apparatus, in order to view a reproduction target image by expanding a part of the same, a user instructs a position and a size of the image to be viewed on the reproduction target image. Responding to this instruction, the image reproducing apparatus clips an image having the specified position and size from the reproduction target image and expands the clipped image so as to output the image to the monitor. Thus, in the conventional image reproducing apparatus, if the user wants to clip a part of the reproduction target image and to expand the clipped image for viewing the same, the user is required to operate an operating key or the like so as to specify a position and a size of the region to be clipped, separately. Therefore, it is difficult to display a desired image quickly and intuitively.

The same is true for taking an image. Specifically, for example, in the conventional image sensing apparatus, if the user wants to record in the recording medium only an image signal inside a noted region on an image sensor in which a noted subject exists, it is necessary to set a position and a size of the noted region separately.

Further, there are also proposed a method of performing an electronic zoom or an optical zoom in accordance with an operation to a touch panel. However, any specific method of the touch panel operation is not proposed. It is desired to propose an operation method that can be performed intuitively. In addition, in a conventional method concerning a clipping operation of an image, there are proposed an operation to input a circle enclosing the subject and an operation to trace a periphery of the subject, but these proposals are not sufficient, and it is desired to propose an operation method that can be performed intuitively.

### SUMMARY OF THE INVENTION

An image reproducing apparatus according to the present invention includes touch panel monitor which has a display screen and receives touch panel operation performed with an operation member touching the display screen, in which an output image obtained by extracting an image inside an extraction region as a part of an entire image area of an input image from the input image is displayed on the touch panel monitor or a monitor of an external display device. The touch panel monitor receives region specifying operation of specifying a position and a size of the extraction region as one type of the touch panel operation when an entire image of the input image is displayed on the display screen. In the region specifying operation, the position and the size of the extraction region are specified on the basis of a position at which the operation member touches the display screen and a period of time while the operation member is touching the display screen, or on the basis of an initial point and a terminal point of a movement locus of the operation member on the display screen, or on the basis of a plurality of positions at which the a plurality of operation members as the operation member touch the display screen.

Further, for example, an image sensing apparatus including the image reproducing apparatus maybe constituted. An input image to the image reproducing apparatus can be obtained by photography with the image sensing apparatus.

A first image sensing apparatus according to the present invention includes a touch panel monitor which has a display screen and receives touch panel operation performed with an operation member touching the display screen, an image sensor which outputs an image signal indicating an incident optical image of a subject, and an extracting unit which extracts an image signal inside an extraction region as a part of an effective pixel region of the image sensor. The touch panel monitor receives region specifying operation of specifying a position and a size of the extraction region as one type of the touch panel operation when the entire image based on the image signal inside the effective pixel region is displayed on the display screen. In the region specifying operation, the position and the size of the extraction region are specified on the basis of a position at which the operation member touches the display screen and a period of time while the operation member is touching the display screen, or on the basis of an initial point and a terminal point of a movement locus of the operation member on the display screen, or on the basis of a plurality of positions at which the a plurality of operation members as the operation member touch the display screen.

A second image sensing apparatus according to the present invention includes a touch panel monitor which has a display screen and receives touch panel operation performed with an operation member touching the display screen, an image pickup unit which has an image sensor to output an image signal indicating an incident optical image of a subject and generates an image by photography from an output signal of the image sensor, a view angle adjustment unit which adjusts an imaging angle of view in the image pickup unit, and an incident position adjustment unit which adjusts an incident position of the optical image on the image sensor. The touch panel monitor receives view angle and position specifying operation for specifying the imaging angle of view and the incident position as one type of the touch panel operation when a taken image obtained by the image pickup unit is displayed on the display screen. In the view angle and position specifying operation, the imaging angle of view and the incident position are specified on the basis of a position at which the operation member touches the display screen and a period of time while the operation member is touching the display screen, or on the basis of an initial point and a terminal point of a movement locus of the operation member on the display screen, or on the basis of a plurality of positions at which the a plurality of operation members as the operation member touch the display screen.

A third image sensing apparatus according to the present invention includes an image pickup unit which has an image sensor to output an image signal indicating an incident optical image of a subject and generates an image by photography from an output signal of the image sensor, a view angle adjustment unit which adjusts an imaging angle of view in the image pickup unit, and an incident position adjustment unit which adjusts an incident position of the optical image on the image sensor. The view angle and position specifying operation for specifying the imaging angle of view and the incident position is received as single operation.

Meanings and effects of the present invention will be apparent from the following description of embodiments. However, the embodiments described below are merely example embodiments of the present invention, and meanings of the present invention and terms of individual elements are not limited to those described in the following embodiments.

### BRIEF DESCRIPTION OF THE DRAWINGS

FIG. 1 illustrates an appearance of a digital camera according to a first embodiment of the present invention.

FIG. 2 is a functional block diagram of the digital camera according to the first embodiment of the present invention.

FIG. 3 is an internal schematic diagram of an image pickup unit illustrated in FIG. 2.

FIG. 4 is an internal block diagram of an operating part illustrated in FIG. 2.

FIG. 5 is a schematic exploded diagram of a touch panel provided to a camera monitor illustrated in FIG. 2.

FIG. 6A illustrates a relationship between a display screen and the XY coordinate plane, and FIG. 6B illustrates a relationship between a two-dimensional image and the XY coordinate plane.

FIG. 7 illustrates a schematic appearance of the digital camera and an external display device.

FIG. 8A illustrates a reproduction target image, and FIG. 8B illustrates a clipped image that is clipped from the reproduction target image.

FIG. 9 is a partial block diagram of the digital camera according to the first embodiment of the present invention.

FIGS. 10A and 10B are diagrams illustrating a relationship between an input image and a clipping frame.

FIG. 11 is a diagram illustrating methods of operating the touch panel according to the first embodiment of the present invention.

FIG. 12 is a diagram illustrating a manner in which the clipping frame is moved so as to track a tracking target according to a second embodiment of the present invention.

FIGS. 13A and 13B are diagrams illustrating a method of setting a tracking target according to the second embodiment of the present invention.

FIG. 14 is a diagram illustrating an input frame image sequence and display image sequence that are supposed in a third embodiment of the present invention.

FIG. 15 is a diagram illustrating a manner in which imaging direction of the digital camera is changed by a panning operation according to the third embodiment of the present invention.

FIG. 16 is a diagram illustrating the input frame image sequence and the clipping frames corresponding to the situation illustrated in FIG. 15.

FIG. 17 is a diagram illustrating an example of the image that can be displayed on the camera monitor according to a fifth embodiment of the present invention.

FIG. 18 is a diagram illustrating a manner in which an effective pixel region exists on the image sensor illustrated in FIG. 3.

FIG. 19 is a diagram illustrating a relationship between the effective pixel region and the XY coordinate plane.

FIG. 20A is a diagram illustrating a frame image that is taken and displayed when the touch panel is operated according to an eighth embodiment of the present invention. FIG. 20B is a diagram illustrating a frame image that is taken and displayed after the touch panel is operated according to the eighth embodiment of the present invention.

FIG. 21 is a diagram illustrating general methods of operating the touch panel for setting a position and a size of the clipping frame according to a ninth embodiment of the present invention.

FIG. 22A is a diagram illustrating a relationship among an original input image, a clipped image extracted from the original input image, a corresponding new input image, and a clipped image extracted from the new input image according to the ninth embodiment of the present invention. FIG. 22B is a diagram illustrating a manner in which the clipping frame is set on the original input image.

FIG. 23 is a diagram illustrating a manner in which an angle of view of a display image is decreased by a touch panel operation as well as a manner in which the angle of view of the display image is increased by another touch panel operation according to the according to the ninth embodiment of the present invention.

FIG. 24A is a diagram illustrating a manner in which a size of the clipping frame set on the original input image is increased, and FIG. 24B is a diagram illustrating a manner in which a size of the clipping frame set on the original input image is decreased, according to the ninth embodiment of the present invention.

FIG. 25 is a diagram illustrating general methods of increase or decrease of a size of the clipping frame and switching the same according to the ninth embodiment of the present invention.

FIGS. 26A and 26B are diagrams illustrating a manner in which the display screen changes when the clipping frame is set according to the ninth embodiment of the present invention.

FIGS. 27A and 27B are diagrams illustrating examples of display icons corresponding to decrease and increase of a size of the clipping frame according to the ninth embodiment of the present invention.

FIG. 28 is a diagram illustrating general methods of setting a changing rate of a size of the clipping frame according to the ninth embodiment of the present invention.

FIG. 29 is a diagram illustrating general processes of informing a user about information of increasing or decreasing of a size of the clipping frame or the like according to the ninth embodiment of the present invention.

FIGS. 30A and 30B are diagrams illustrating examples of icons concerning an instruction for canceling the size change of the clipping frame according to the ninth embodiment of the present invention.

FIG. 31 is a diagram illustrating a manner of the display screen or the like in a first operational example according to the ninth embodiment of the present invention.

FIG. 32 is a diagram illustrating a manner of the display screen or the like in a second operational example according to the ninth embodiment of the present invention.

FIG. 33 is a diagram illustrating a manner of the display screen or the like in a third operational example according to the ninth embodiment of the present invention.

### DETAILED DESCRIPTION OF THE PREFERRED EMBODIMENTS

Hereinafter, embodiments of the present invention will be described specifically with reference to the attached drawings. In the drawings to be referred to, the same part is denoted by the same reference numeral or symbol, so that overlapping description of the same part is omitted as a rule.

### First Embodiment

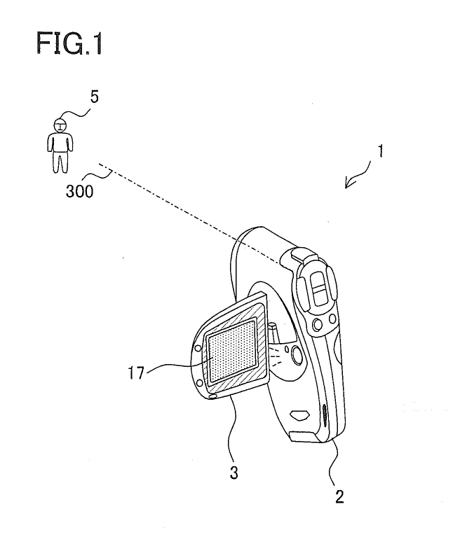

A first embodiment of the present invention will be described. FIG. 1 illustrates an appearance of a digital camera 1 according to a first embodiment of the present invention. The digital camera 1 is a digital still camera that can take only still images or a digital video camera that can take still images and moving images. Numeral 5 denotes a subject existing within a photographing range of the digital camera 1.

The digital camera 1 includes a main casing 2 like a roundish rectangular solid and a monitor casing 3 like a plate, which are connected to each other via a connection. The monitor casing 3 is equipped with a camera monitor 17 as a display device. The monitor casing 3 is attached to the main casing 2 in an openable and closable manner, so that a relative position of the monitor casing 3 to the main casing 2 is variable. FIG. 1 illustrates the state where the monitor casing 3 is opened. A display screen of the camera monitor 17 can be viewed by a user only in the state where the monitor casing 3 is opened. Hereinafter, it is supposed that the monitor casing 3 is always opened. In FIG. 1, an axis 300 indicates an optical axis of the digital camera 1.

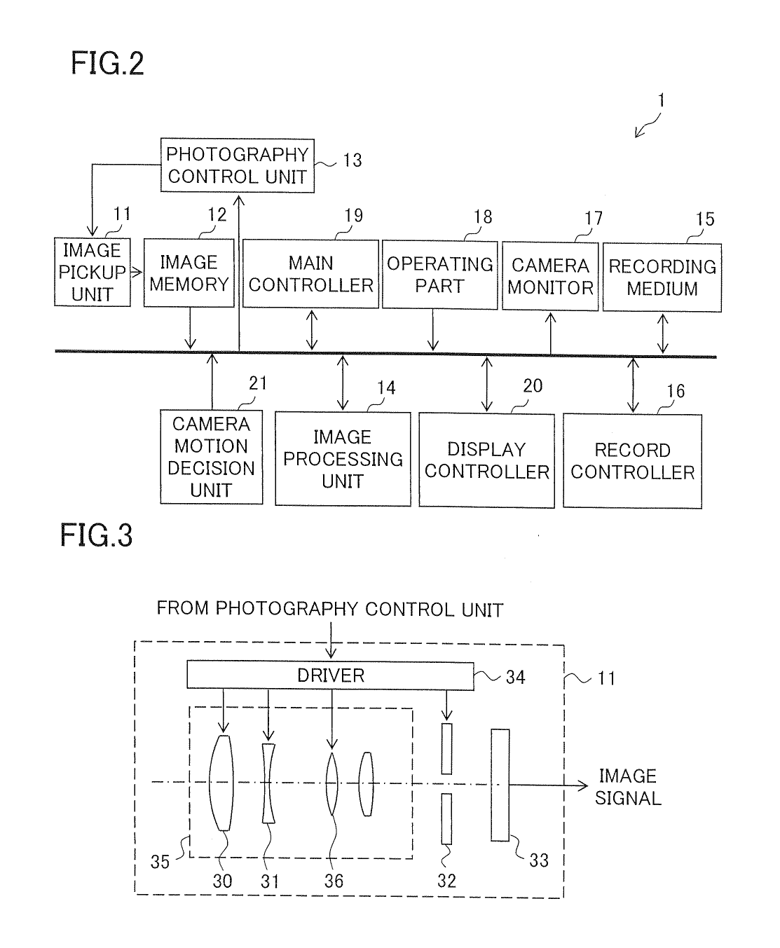

FIG. 2 is a functional block diagram of the digital camera 1. The digital camera 1 includes individual portions denoted by numerals 11 to 21.

FIG. 3 is an internal schematic diagram of an image pickup unit 11 illustrated in FIG. 2. The image pickup unit 11 includes an optical system 35, an aperture stop 32, an image sensor 33, and a driver 34. The optical system 35 is constituted of a plurality of lenses including a zoom lens 30, a focus lens 31 and a correction lens 36. The zoom lens 30 and the focus lens 31 can be moved in the optical axis direction, and the correction lens 36 can be moved in a direction inclined to the optical axis. Specifically, the correction lens 36 is disposed in the optical system 35 so as to be capable of moving on a two-dimensional plane perpendicular to the optical axis.

Incident light from the subject enters the image sensor 33 via the individual lenses constituting the optical system 35 and the aperture stop 32. The lenses constituting the optical system 35 form an optical image of the subject on the image sensor 33. The image sensor 33 is constituted of a charge coupled device (CCD) or a complementary metal oxide semiconductor (CMOS) image sensor. The image sensor 33 performs photoelectric conversion of the optical image of the subject received via the optical system 35 and the aperture stop 32, and outputs an electric signal obtained by the photoelectric conversion as an image signal.

The driver 34 moves the zoom lens 30, the focus lens 31 and the correction lens 36 on the basis of a lens control signal from a photography control unit 13. When a position of the zoom lens 30 is changed, a focal length of the image pickup unit 11 and an angle of view of imaging with the image pickup unit 11 (hereinafter referred to as “imaging angle of view” simply) are changed. At the same time, an optical zoom magnification is changed. When a position of the focus lens 31 is changed, a focal position of the image pickup unit 11 is adjusted. When a position of the correction lens 36 is changed, the optical axis is shifted, so that an incident position of the optical image on the image sensor 33 is changed. In addition, the driver 34 controls opening amount of the aperture stop 32 (size of the opening part) on the basis of an aperture stop control signal from the photography control unit 13. As the opening amount of the aperture stop 32 increases, incident light amount per unit time in the image sensor 33 increases.

An analog front end (AFE) that is not illustrated amplifies an analog image signal output from the image sensor 33 and converts the signal into a digital signal (digital image signal). The obtained digital signal is recorded as image data of a subject image in an image memory 12 such as a synchronous dynamic random access memory (SDRAM) or the like. The photography control unit 13 adjusts the imaging angle of view, the focal position, and incident light amount in the image sensor 33 on the basis of the image data, a user's instruction or the like. Note that the image data is a type of video signal which includes, for example, a luminance signal and a color difference signal.

An image processing unit 14 processes the image data of the subject image stored in the image memory 12 by necessary image processings (noise reduction process, edge enhancement process, and the like). A recording medium 15 is a nonvolatile memory constituted of a magnetic disk, a semiconductor memory, or the like. Image data after the image processing by the image processing unit 14 or image data before the image processing (so-called RAW data) can be recorded in the recording medium 15.

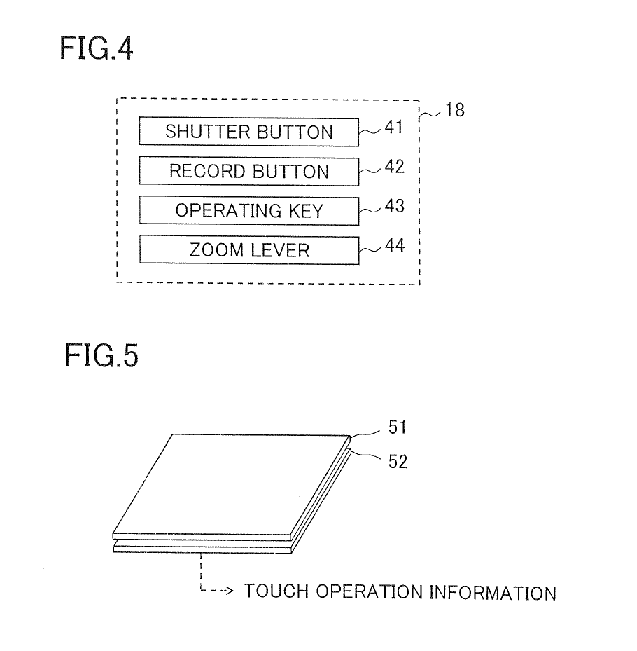

A record controller 16 performs record control necessary for recording various data in the recording medium 15. The camera monitor 17 displays images obtained by the image pickup unit 11 or images recorded in the recording medium 15. An operating part 18 is a part for a user to do various operations to the digital camera 1. As illustrated in FIG. 4, the operating part 18 includes a shutter button 41 for instructing to take a still image, a record button 42 for instructing to start and end taking a moving image, operating keys 43 including a cross key and the like, and a zoom lever 44 for instructing to increase or decrease the imaging angle of view. A main controller 19 controls operations of individual portions in the digital camera 1 integrally in accordance with contents of an operation instruction performed to the operating part 18.

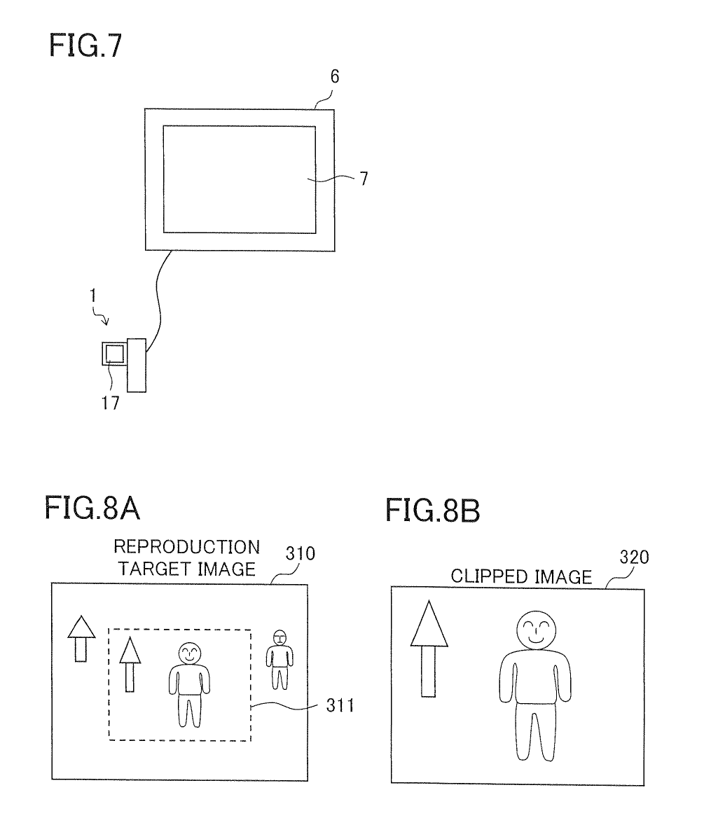

A display controller 20 controls display contents of the camera monitor 17 or the monitor of the external display device (TV monitor 7 that will be described later as illustrated in FIG. 7). The image recorded in the image memory 12 or the recording medium 15 can be displayed on the camera monitor 17 or the monitor of the external display device. A camera motion decision unit 21 detects content of motion of the main casing 2 by using a sensor and the image processing.

Operation modes of the digital camera 1 includes an imaging mode in which images (still images or moving images) can be taken and recorded, and a reproducing mode in which images (still images or moving images) recorded in the recording medium 15 are reproduced and displayed on the camera monitor 17 or the monitor of the external display device. The operation mode is changed between the individual modes in accordance with the operation of the operating key 43.

In the imaging mode, imaging of a subject is performed periodically at a predetermined frame period, so that the image pickup unit 11 outputs the image signal indicating the photographed image sequence of the subject. The image sequence such as the photographed image sequence means a set of images arranged in time sequence. Image data of one frame period expresses one image. The one image expressed by the image data of one frame period is also referred to as a frame image.

The camera monitor 17 is equipped with a touch panel. FIG. 5 is a schematic exploded diagram of the touch panel. The touch panel of the camera monitor 17 includes a display screen 51 constituted of a liquid crystal display or the like, and a touch detection unit 52 which detects a position where an operation member touches on the display screen 51 (position to which a pressure is applied). The operation member is a finger, a pen, or the like. In the following description, it is supposed that the operation member is a finger.

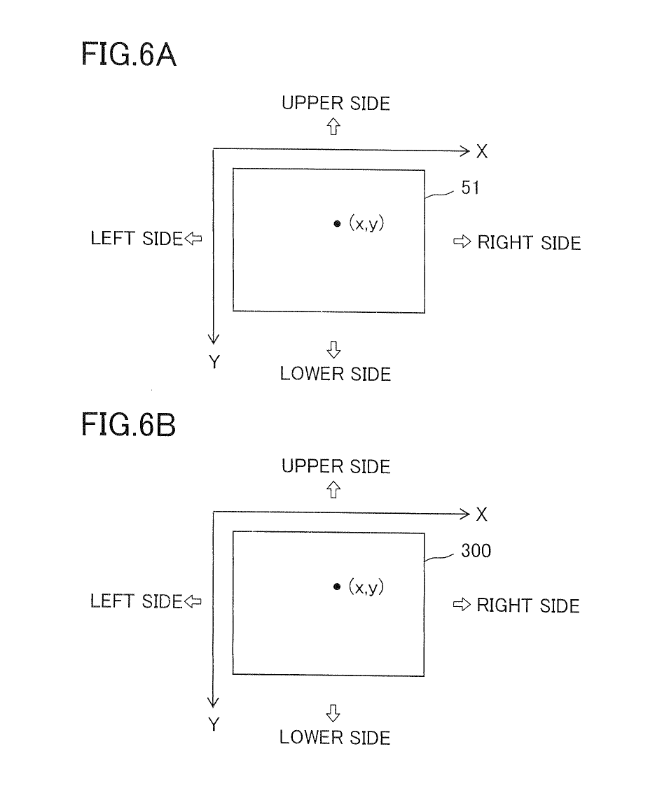

As illustrated in FIG. 6A, a position on the display screen 51 is defined as a position on a two-dimensional XY coordinate plane. In addition, as illustrated in FIG. 6B, an arbitrary two-dimensional image is also handled as an image on the XY coordinate plane in the digital camera 1. In FIG. 6B, the rectangular frame denoted by numeral 300 indicates a contour frame of the two-dimensional image. The XY coordinate plane includes coordinate axes including an X axis extending in the horizontal direction of the display screen 51 and the two-dimensional image 300, and a Y axis extending in the vertical direction of the display screen 51 and the two-dimensional image 300. The images described in this specification are all two-dimensional images unless otherwise described. A position of a noted point on the display screen 51 and the two-dimensional image 300 is denoted (x,y). The symbol x denotes an X axis coordinate value of the noted point and a horizontal position of the noted point on the display screen 51 and the two-dimensional image 300. The symbol y denotes a Y axis coordinate value of the noted point and a vertical position of the noted point on the display screen 51 and the two-dimensional image 300.

In the display screen 51 and the two-dimensional image 300, it is supposed that as a value of x which is the X axis coordinate value of the noted point increases, the position of the noted point moves to the right side which is a positive side of the X axis (right side in the XY coordinate plane), and that as a value of y which is the Y axis coordinate value of the noted point increases, the position of the noted point moves to the lower side which is a positive side of the Y axis (lower side in the XY coordinate plane). Therefore, in the display screen 51 and the two-dimensional image 300, as a value of x which is an X axis coordinate value of the noted point decreases, the position of the noted point moves to the left side (left side in the XY coordinate plane). Further, as a value of y which is the Y axis coordinate value of the noted point decreases, the position of the noted point moves to the upper side (upper side in the XY coordinate plane).

When the two-dimensional image 300 is displayed on the display screen 51 (when the two-dimensional image 300 is displayed on the entire display screen 51), the image at the position (x,y) on the two-dimensional image 300 is displayed at the position (x,y) on the display screen 51.

When the operation member touches the display screen 51, the touch detection unit 52 illustrated in FIG. 5 output touch operation information indicating the touched position (x,y) in real time. Hereinafter, the operation of touching the display screen 51 with the operation member is referred to as “touch panel operation”.

The digital camera 1 performs a characteristic operation according to the touch panel operation in the reproducing mode. When an image is reproduced, the digital camera 1 works as an image reproducing apparatus. The digital camera 1 can also display images (still images or moving images) recorded in the recording medium 15 on the monitor of an external display device such as a television receiver or the like. FIG. 7 illustrates a television receiver 6 as an external display device that is supposed in this embodiment. The television receiver 6 is equipped with a TV monitor 7 constituted of a liquid crystal display or the like. When a video signal based on record data in the recording medium 15 is sent from the digital camera 1 to the television receiver 6 via wired or wireless communication, the image based on record data of the recording medium 15 can be displayed on the TV monitor 7.

In the first embodiment, hereinafter, an operation of the digital camera 1 in the reproducing mode, and display contents of the camera monitor 17 and the TV monitor 7 will be described. In the reproducing mode, a person who performs operations including the touch panel operation to the digital camera 1 is referred to as “operator”, and a person who views the TV monitor 7 is referred to as “viewer”. The operator can also be one of viewers. The image recorded in the recording medium 15 which is an image to be reproduced is referred to as “reproduction target image”. The reproduction target image can be obtained by photography with the digital camera 1. The reproduction target image is a still image or a moving image.

FIG. 8A illustrates the reproduction target image. A solid line frame denoted by numeral 310 is a contour of the reproduction target image. In FIG. 8A, a broken line frame denoted by numeral 311 is a clipping frame set by the display controller 20 illustrated in FIG. 2. A region within the clipping frame is referred to as “clipping region”. The clipping region is a part of the entire image area (in other words, the entire image region) of the reproduction target image. An outer shape of the clipping frame may be other than the rectangular shape, but in the following description, the outer shape of the clipping frame is the rectangular shape unless otherwise described. The display controller 20 clips an image inside the clipping frame from the reproduction target image (in other words, extracts an image inside the clipping frame from the reproduction target image). The image obtained by the clipping is referred to as “clipped image”. FIG. 8B illustrates a clipped image 320 obtained by clipping the image inside the clipping frame 311 from the reproduction target image 310. The display controller 20 can display the reproduction target image or the clipped image on the TV monitor 7 and the camera monitor 17. Hereinafter, an operation when the clipped image is displayed on the TV monitor 7 will be described as a characteristic operation of the digital camera 1.

When the clipped image is displayed on the TV monitor 7 or the camera monitor 17, a resolution of the clipped image is converted into a resolution that is suitable as a resolution of the TV monitor 7 or the camera monitor 17. For instance, if the numbers of pixels of the image inside the clipping frame on the reproduction target image in the horizontal and the vertical directions are respectively 640 and 360, and if the numbers of pixels of the display screen of the TV monitor 7 in the horizontal and the vertical directions are respectively 1920 and 1080, the number of pixels of the image inside the clipping frame is multiplied by three in each of the horizontal and the vertical directions by a resolution conversion method using a known pixel interpolation method or the like, and then the image data is given to the TV monitor 7.

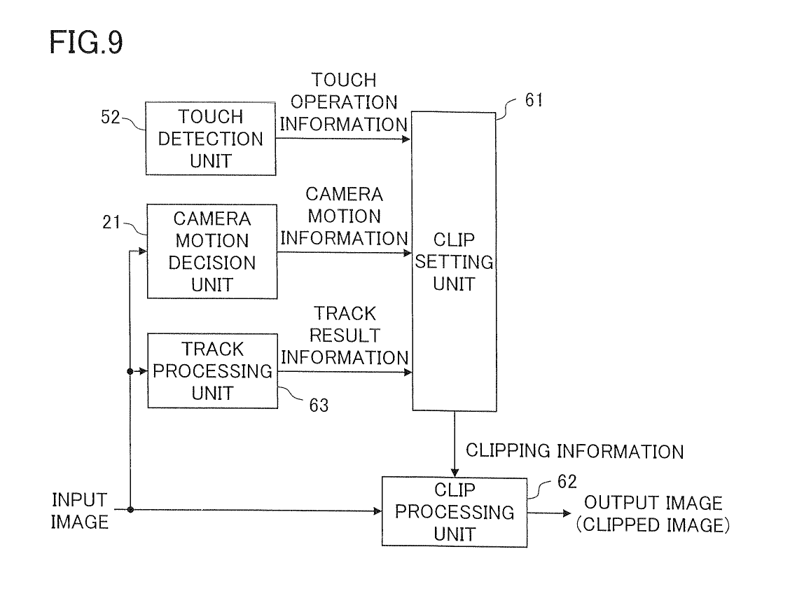

A block diagram of the portion that realizes the above-mentioned generation of the clipped image and the display operation is illustrated in FIG. 9. The camera motion decision unit 21 and the touch detection unit 52 illustrated in FIG. 9 are the same as those illustrated in FIGS. 2 and 5. A clip setting unit 61, a clip processing unit 62 and a track processing unit 63 illustrated in FIG. 9 can be disposed in the image processing unit 14 or the display controller 20 illustrated in FIG. 2. In the first embodiment, for example, the clip setting unit 61 and the clip processing unit 62 are disposed in the display controller 20, and the track processing unit 63 is disposed in the image processing unit 14.

The clip setting unit 61 generates clipping information for clipping the clipped image from the input image that is the reproduction target image on the basis of touch operation information from the touch detection unit 52, camera motion information from the camera motion decision unit 21, and track result information from the track processing unit 63. The clip processing unit 62 generates the clipped image (in other words, extracts an image inside the clipping frame from the reproduction target image) by actually clipping the image inside the clipping frame from the reproduction target image on the basis of the clipping information. The generated clipped image itself or the image after a predetermined process performed on the generated clipped image can be displayed on the TV monitor 7 as an output image. In this case, the entire image of the reproduction target image is displayed on the camera monitor 17. However, it is possible to display on the camera monitor 17 the same image as the image displayed on the TV monitor 7. Note that the display controller 20 also performs timing control of image reproduction on the TV monitor 7 and the camera monitor 17 (details will be described later in the other embodiment).

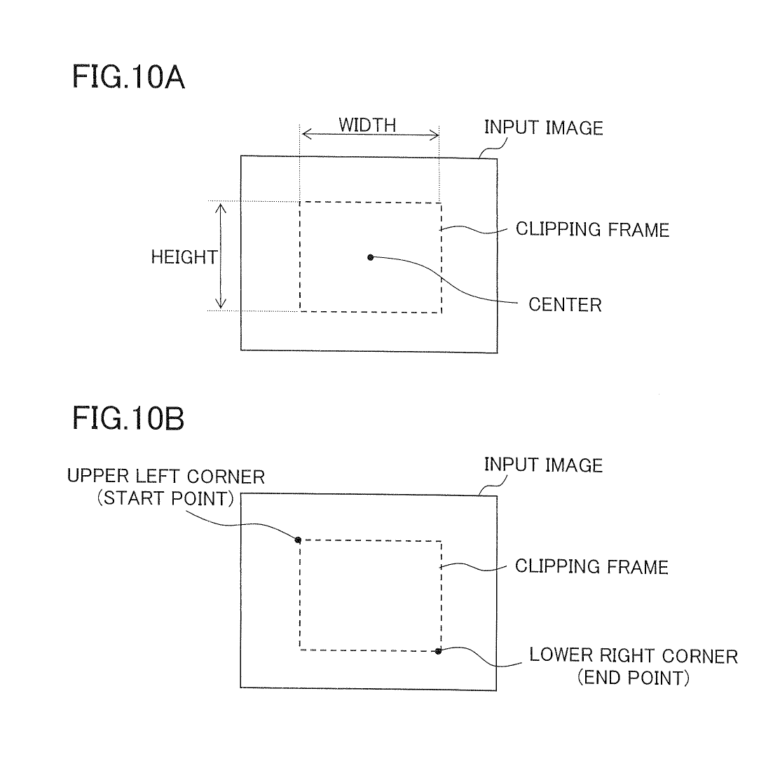

The clipping information defines a condition for generating the clipped image as the output image from the input image as the reproduction target image. As long as the output image can be generated from the input image, any form of the clipping information can be adopted. For instance, as illustrated in FIG. 10A, a center position of the clipping frame on the input image and a width and a height of the clipping frame on the input image should be included in the clipping information. Further, in the case where an aspect ratio of the output image is fixed, it is sufficient if the center position of the clipping frame and one of the width and the height of the clipping frame is included in the clipping information. The width of the clipping frame indicates a size of the clipping frame in the horizontal direction (X axis direction), and the height of the clipping frame indicates a size of the clipping frame in the vertical direction (Y axis direction). Alternatively, for example, as illustrated in FIG. 10B, the clipping information may include an upper left corner position and a lower right corner position of the clipping frame on the input image. Further, the points corresponding to the upper left corner position and the lower right corner position of the clipping frame are also referred to as a start point and an end point, respectively.

Conversion from a coordinate system of the input image to a coordinate system of the output image can be realized by using a geometric conversion (e.g., affine conversion). Therefore, it is possible that the clipping information includes a conversion parameter of the geometric conversion for generating the output image from the input image. In this case, the clip processing unit 62 performs the geometric conversion in accordance with the conversion parameter in the clipping information so that the output image is generated from the input image.

The camera motion information and the track result information are additional information for setting the clipping information, and it is possible that the camera motion information and/or the track result information are not reflected on the clipping information at all (in this case, the camera motion decision unit 21 and/or the track processing unit 63 are unnecessary). A method of using also the camera motion information or the track result information will be described later in the other embodiments, and this embodiment describes a method of setting the clipping information in accordance with the touch operation information.

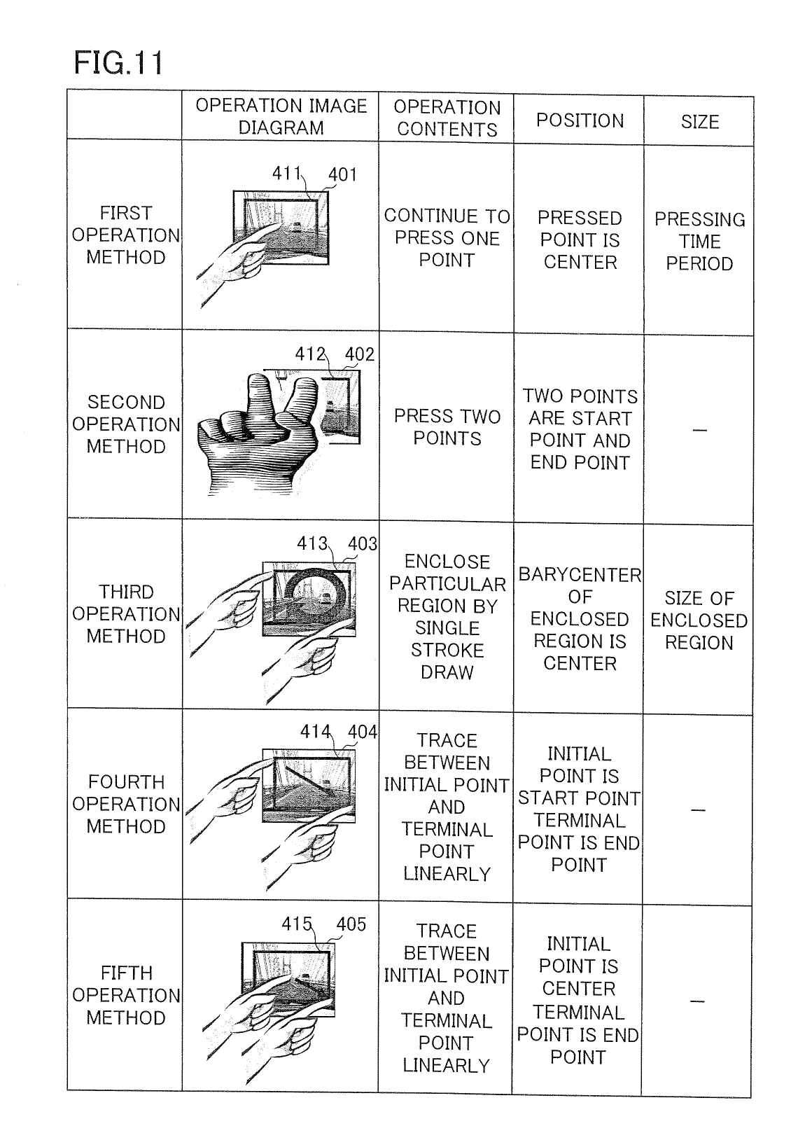

The operator can specify a position and a size of the clipping frame by a plurality of operation methods. As the plurality of operation methods, first to fifth operation methods are exemplified as follows. FIG. 11 illustrates a table including image diagrams, outlines of operations and positions and sizes of the specified clipping frames of the first to the fifth operation methods. In FIG. 11, numerals 401 to 405 denote display screens 51 in the applications of the first to the fifth operation methods, respectively. Each of the display screens displays the entire image of the reproduction target image. In FIG. 11, rectangular frames 411 to 415 denote clipping frames on the display screen 51 in the applications of the first to the fifth operation methods, respectively. In the state where the entire image of the reproduction target image is displayed on the display screen 51, the operator performs the touch panel operation by any one of the first to the fifth operation methods. Then, the clipping information is set in accordance with the touch panel operation, and the clipped image is generated and displayed. Note that in the following description, for convenience of description, to touch the display screen 51 with a finger may be expressed as “to press” or “to press down”. In addition, a “finger” in the following description of the touch panel operation means a finger to be contact with the display screen 51, unless otherwise described.

[First Operation Method]

A first operation method will be described. The touch panel operation according to the first operation method is an operation of pressing one point on the display screen 51 with a finger continuously for necessary time period. The touch detection unit 52 outputs to the clip setting unit 61 the touch operation information indicating a position (x₁,y₁) that is pressed by this operation continuously for the time period while the point is being pressed. The clip setting unit 61 sets the clipping information in accordance with the touch operation information so that the position (x₁,y₁) becomes the center position of the clipping frame and that a size of the clipping frame corresponds to the time period while the position (x₁,y₁) is being pressed.

In the first operation method, it is supposed that the aspect ratio of the clipping frame is prefixed. If the above-mentioned pressing time period is zero or substantially zero, a width and a height of the clipping frame are the same as those of the input image. As the pressing time period increases from zero, a width and a height of the clipping frame is decreased from those of the input image. During the period in which the touch panel operation according to the first operation method is performed, the clipping frame to be set is actually displayed on the display screen 51 (display screen 401 in FIG. 11). Therefore, as the pressing time period increases, the clipping frame on the camera monitor 17 becomes small, and the size of the clipping frame is fixed when the finger is released from the display screen 51. Note that a relationship between the pressing time period and increasing or decreasing of the size of the clipping frame may be opposite. Specifically, it is possible to increase a width and a height of the clipping frame from zero as the pressing time period increases from zero.

After setting the clipping information, the output image is generated from the image inside the clipping frame according to the clipping information and is displayed on the TV monitor 7 (the same is true in second to fifth operation methods).

[Second Operation Method]

A second operation method will be described. The touch panel operation according to the second operation method is an operation of pressing two points on the display screen 51 with two fingers simultaneously. The touch detection unit 52 outputs to the clip setting unit 61 the touch operation information indicating the two positions (x_{2A},y_{2A}) and (x_{2B},y_{2B}) that are pressed by this operation. Here, on the display screen 51 and on the XY coordinate plane, it is supposed that the position (x_{2A},y_{2A}) is located on the upper left side of the position (x_{2B},y_{2B}) (see FIG. 6A). Therefore, x_{2A}<x_{2B} and y_{2A}<y_{2B} are satisfied.

Simply, for example, the clip setting unit 61 sets the clipping information in accordance with the touch operation information, so that the position (x_{2A},y_{2A}) becomes a start point of the clipping frame and that the position (x_{2B},y_{2B}) becomes an end point of the clipping frame (see FIG. 10B). However, if the positions (x_{2A},y_{2A}) and (x_{2B},y_{2B}) specified by the operator are used as they are as the start point and the end point of the clipping frame so as to generate the clipped image, the aspect ratio of the clipped image may not agree with a desired aspect ratio (aspect ratio of the TV monitor 7 in this example). In this case, it is possible to expand the image in the clipping frame in the horizontal or the vertical direction so that the aspect ratio of the clipped image and the desired aspect ratio agree with each other, and to display the expanded image on the TV monitor 7. Alternatively, it is possible to reset the start point and the end point of the clipping frame in which the aspect ratio agrees with the desired aspect ratio, in accordance with the positions (x_{2A},y_{2A}) and (x_{2B},y_{2B}).

In addition, for example, it is possible to set the clipping information so that |x_{2A}−x_{2B}| becomes a width of the clipping frame and that the aspect ratio of the clipping frame agrees with a desired aspect ratio. In this case, the position of the start point of the clipping frame is (x_{2A},y_{2A}). Alternatively, the position of the end point of the clipping frame is (x_{2B},y_{2B}). Alternatively, the center position of the clipping frame is set to ((x_{2A}+x_{2B})/2,(y_{2A}+y_{2B})/2).

In addition, for example, the clipping information may be set so that |y_{2A}−y_{2B}| becomes a height of the clipping frame and that the aspect ratio of the clipping frame agrees with a desired aspect ratio. In this case, the position of the start point of the clipping frame is (x_{2A},y_{2A}). Alternatively, the position of the end point of the clipping frame is (x_{2B},y_{2B}). Alternatively, the center position of the clipping frame is ((x_{2A}+x_{2B})/2,(y_{2A}+y_{2B})/2).

[Third Operation Method]

A third operation method will be described. The touch panel operation according to the third operation method is an operation of touching the display screen 51 with a finger and enclosing a particular region (desired by the operator) on the display screen 51 by moving the finger. In this case, the finger tip drawing a figure enclosing the particular region does not part from the display screen 51. In other words, the finger of the operator draws the figure enclosing the particular region with a single stroke.

In the touch panel operation according to the third operation method, the finger of the operator first starts to touch a position (x_{3A},y_{3A}) on the display screen 51, and then the finger moves from the position (x_{3A},y_{3A}) to the position (x_{3B},y_{3B}) on the display screen 51 so as to enclose the periphery of the particular region. Until the finger reaches the position (x_{3B},y_{3B}) from the position (x_{3A},y_{3A}), the finger does not part from the display screen 51. The operator releases the finger from the display screen 51 when the finger reaches the position (x_{3B},y_{3B}). Therefore, a movement locus of the finger from the position (x_{3A},y_{3A}) as an initial point to the position (x_{3B},y_{3B}) as a terminal point is specified by the touch operation information from the touch detection unit 52. The position (x_{3A},y_{3A}) and the position (x_{3B},y_{3B}) should agree with each other ideally, but they don't agree with each other actually in many cases. If they don't agree with each other, a straight line or a curve connecting the position (x_{3A},y_{3A}) and the position (x_{3B},y_{3B}) may be added to the movement locus, for example.

The clip setting unit 61 sets the clipping information in accordance with the movement locus specified by the touch operation information so that a barycenter of the figure enclosed by the movement locus becomes the center of the clipping frame and that a size of the clipping frame corresponds to the size of the figure enclosed by the movement locus. In this case, as a size of the figure increases, a size of the clipping frame is set larger. For instance, a rectangular frame that has the center as the barycenter of the figure and is a smallest rectangular frame including the figure is set as the clipping frame. In this case, an aspect ratio of this rectangular frame should agree with a desired aspect ratio (aspect ratio of the TV monitor 7 in this example).

[Fourth Operation Method]

A fourth operation method will be described. The touch panel operation according to the fourth operation method is an operation of touching the display screen 51 with a finger and tracing a diagonal of a display region to be the clipping region with the finger.

In the touch panel operation according to the fourth operation method, the finger of the operator first starts to touch a position (x_{4A},y_{4A}) on the display screen 51, and then the finger moves linearly from the position (x_{4A},y_{4A}) to a position (x_{4B},y_{4B}) on the display screen 51. Until the finger reaches the position (x_{4B},y_{4B}) from the position (x_{4A},y_{4A}), the finger does not part from the display screen 51. The operator releases the finger from the display screen 51 when the finger reaches the position (x_{4B},y_{4B}). Therefore, a movement locus of the finger from the position (x_{4A},y_{4A}) as an initial point to the position (x_{4B},y_{4B}) as a terminal point is specified by the touch operation information from the touch detection unit 52. Here, on the display screen 51 and on the XY coordinate plane, it is supposed that the position (x_{4A},y_{4A}) is located on the upper left side of the position (x_{4B},y_{4B}) (see FIG. 6A). Therefore, x_{4A}<x_{4B} and y_{4A}<y_{4B} are satisfied.

The clip setting unit 61 sets the clipping information in accordance with the touch operation information so that the position (x_{4A},y_{4A}) becomes the start point of the clipping frame and that the position (x_{4B},y_{4B}) becomes the end point of the clipping frame (see FIG. 10B). In the case of this setting, a desired aspect ratio (aspect ratio of the TV monitor 7 in this example) is also considered. The method of setting the clipping frame (clipping information) with consideration of the desired aspect ratio is the same as that described above in the second operation method. Although the operation described above is the case where the position of the upper left corner (x_{4A},y_{4A}) and the position of the lower right corner (x_{4B},y_{4B}) in the clipping frame are specified, it is possible to specify a position of an upper right corner and a position of a lower left corner in the clipping frame by the touch panel operation.

[Fifth Operation Method]

A fifth operation method will be described. The touch panel operation according to the fifth operation method is an operation of touching the display screen 51 with a finger and tracing a half diagonal of a display region to be the clipping region with the finger.

In the touch panel operation according to the fifth operation method, the finger of the operator first starts to touch a position (x_{5A},y_{5A}) on the display screen 51, and then the finger moves linearly from the position (x_{5A},y_{5A}) to a position (x_{5B},y_{5B}) on the display screen 51. Until the finger reaches the position (x_{5B},y_{5B}) from the position (x_{5A},y_{5A}), the finger does not part from the display screen 51. The operator releases the finger from the display screen 51 when the finger reaches the position (x_{5B},y_{5B}). Therefore, a movement locus of the finger from the position (x_{5A},y_{5A}) as an initial point to the position (x_{5B},y_{5B}) as a terminal point is specified by the touch operation information from the touch detection unit 52. Here, on the display screen 51 and on the XY coordinate plane, it is supposed that the position (x_{5A},y_{5A}) is located on the upper left side of the position (x_{5B},y_{5B}) (see FIG. 6A). Therefore, x_{5A}<x_{5B} and y_{5A}<y_{5B} are satisfied.

The clip setting unit 61 sets the clipping information in accordance with the touch operation information so that the position (x_{5A},y_{5A}) becomes the center position of the clipping frame and that the position (x_{5B},y_{5B}) becomes the end point of the clipping frame (see FIG. 10B). Therefore, a width of the clipping frame is expressed by (|x_{5A}−x_{5B}|×2). However, in the case of this setting, it is preferable to take a desired aspect ratio (aspect ratio of the TV monitor 7 in this example) into account. The method of setting the clipping information and the clipping frame with consideration of the desired aspect ratio is the same as that described above in the second operation method.

Specifically, if the positions (x_{5A},y_{5A}) and (x_{5B},y_{5B}) specified by the operator are used as they are as the center position and the position of the end point of the clipping frame so as to generate the clipped image, the aspect ratio of the clipped image may not agree with a desired aspect ratio. In this case, for example, it is possible to expand the image in the clipping frame in the horizontal or the vertical direction so that the aspect ratio of the clipped image and the desired aspect ratio agree with each other, and to display the expanded image on the TV monitor 7. Alternatively, it is possible to reset the center and the end point of the clipping frame in which the aspect ratio agrees with the desired aspect ratio, in accordance with the positions (x_{5A},y_{5A}) and (x_{5B},y_{5B}).

In addition, for example, the clipping information may be set so that (|x_{5A}−x_{5B}|×2) becomes a width of the clipping frame and that the aspect ratio of the clipping frame agrees with a desired aspect ratio. In this case, the center position of the clipping frame is set to (x_{5A},y_{5A}). In addition, for example, the clipping information may be set so that (|y_{5A}−y_{5B}|×2) becomes a height of the clipping frame and that the aspect ratio of the clipping frame agrees with a desired aspect ratio. In this case, too, the center position of the clipping frame is set to (x_{5A},y_{5A}).

Although the operation described above is the case where the center position (x_{5A},y_{5A}) and the lower right corner position (x_{5B},y_{5B}) of the clipping frame are specified, it is possible to specify not the lower right corner position but a position of the upper left corner, the upper right corner or the lower left corner in the clipping frame by the touch panel operation.

In the digital camera 1, any one of the first to the fifth operation methods may be adopted. It is possible to configure the digital camera 1 so that a plurality of operation methods among the first to the fifth operation methods can be used for the touch panel operation, and that the digital camera 1 automatically decide which one of the operation methods is used as the touch panel operation by deciding the number of fingers touching the display screen 51 and the moving state of the finger touching the display screen 51 from the touch operation information.

As described above, a position and a size of the clipping frame can be specified by the intuitive touch panel operation (region specifying operation). Therefore, the operator can set an angle of view and the like of the reproduction image to desired ones quickly and easily. In each operation method, when the operator gives the touch panel operation to the digital camera 1, the finger does not part from the display screen 51 of the touch panel (the finger is not released from the display screen 51 of the touch panel). In other words, a position and a size of the clipping frame are specified by the single operation without separating the finger from the display screen 51 (the single operation is finished when separating the finger from the display screen 51). Therefore, the operation is easier and finishes in a shorter time than the conventional apparatus which requires specifying a position of the clipping frame and a size of the clipping frame separately.

For instance, in the conventional apparatus, a first operation (with a cursor key, for example) is performed for specifying the center position of the clipping frame, and a second operation (with a zoom button, for example) for specifying a size of the clipping frame is performed separately and differently from the first operation, so that specifying a position and a size of the clipping frame is completed. In other words, in the conventional apparatus, the operation of specifying the center position of the clipping frame and the operation for specifying a size of the clipping frame are performed at different timings by different operation methods. In contrast, in this embodiment, the operation of specifying the position of the clipping frame and the operation of specifying the size of the clipping frame are made to be common. Therefore, when the operation of specifying the position of the clipping frame is completed, the operation of specifying the size of the clipping frame is completed at the same time. Further, when the operation of specifying the size of the clipping frame is completed, the operation of specifying the position of the clipping frame is completed at the same time. In other words, in this embodiment, a position and a size of the clipping frame are designated by a single operation that cannot be divided.

Further, in comparison with “an operation of inputting a circle enclosing a subject and an operation of tracing a periphery of the subject” described in JP-A-2010-062853, paragraph 0079, the individual operation methods illustrated in FIG. 11 have the following prepotency.

In the first operation method, the position at which the finger contact is set as the center position of the clipping frame. Therefore, the user can precisely set the center position of the clipping frame to a desired position.

In the second operation method, a position and a size of the clipping frame are determined when the two fingers contact with the display screen 51. Therefore, the user can instantly complete specifying a position and a size of the clipping frame.

In the fourth operation method, diagonal corners of the clipping frame are located at positions of the initial point and the terminal point of the movement locus of the finger. Therefore, the user can set a position and a size of the clipping frame to a desired position and size correctly and easily. In addition, it is easier to complete quickly the setting of the position and the like of the clipping frame than the operation of inputting a circle enclosing the subject or the operation of tracing the periphery of the subject.

Also by the fifth operation method, similarly to the fourth operation method, the user can easily set a position and a size of the clipping frame to a desired position and size correctly, and can complete more quickly and easily the setting of a position and the like of the clipping frame than the operation of inputting a circle enclosing the subject or the operation of tracing the periphery of the subject.

Further, in the above description, it is supposed that the clipped image generated by the touch panel operation is displayed on the TV monitor 7, but it is possible to display the clipped image on the camera monitor 17 (the same is true in second to sixth embodiments described later). Specifically, for example, before the touch panel operation is performed, the entire image of the reproduction target image (e.g., the image 310 illustrated in FIG. 8A) may be displayed by using the entire display screen 51 of the camera monitor 17. Then, after the touch panel operation, the generated clipped image (e.g., the image 320 illustrated in FIG. 8B) may be displayed by using the entire display screen 51 in accordance with the touch panel operation.

### Second Embodiment

A second embodiment of the present invention will be described. The second embodiment and a third to sixth embodiments described later are embodiments based on the description of the first embodiment, and the description of the first embodiment is applied also to the second to sixth embodiments as long as no contradiction arises. Also in the second to sixth embodiments, similarly to the first embodiment, an operation of the digital camera 1 in the reproducing mode will be described. In addition, also in the second to sixth embodiments, similarly to the first embodiment, it is supposed that the television receiver 6 is connected to the digital camera 1.

In the second embodiment, it is an assumption that the reproduction target image as the input image is a moving image. In addition, it is supposed that the number of pixels in the display screen of the TV monitor 7 is larger than the number of pixels of the image in the clipping frame (therefore, a size of the image in the clipping frame is enlarged when the image inside the clipping frame is clipped and displayed on the TV monitor 7).

The reproduction target image that is a moving image is constituted of a plurality of frame images arranged in time sequence. Each of the frame images constituting the input image as the reproduction target image is particularly referred to as an input frame image, and the n-th input frame image is denoted by symbol Fₙ (n is an integer). The input frame images F₁, F₂, F₃ and so on of the first, second, third and so on are sequentially displayed so that the reproduction target image as the moving image is reproduced. Note that in this specification, for simple description, a symbol may be referred to so that a name corresponding to the symbol may be omitted or shortened. For instance, “input frame image Fₙ” may be simply referred to as “image Fₙ”, and both indicate the same thing.

In the second embodiment, a position and the like of the clipping frame are determined by the touch panel operation, the subject in the clipping frame is tracked so as to update a position of the clipping frame. Therefore, a position and a size of the clipping frame are determined in accordance with not only the touch operation information from the touch detection unit 52 but also the track result information from the track processing unit 63 illustrated in FIG. 9.

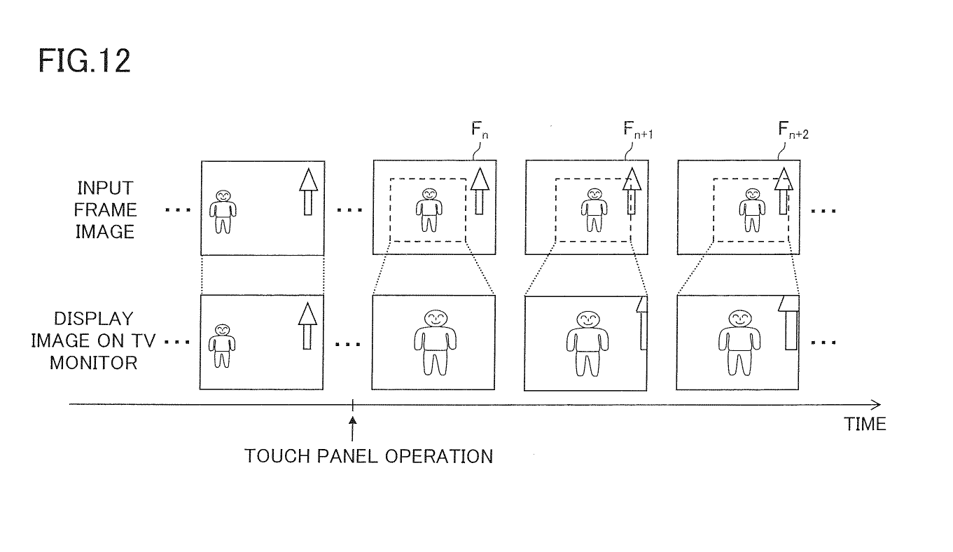

With reference to FIG. 12, a specific operational example will be described. When reproduction of the reproduction target image is started, input frame images that are sequentially read from the recording medium 15 are supplied to the clip processing unit 62 illustrated in FIG. 9. Each of the input frame images is also supplied to the track processing unit 63. Before the touch panel operation for setting the clipping information is performed, the entire image of the input frame image is displayed on the TV monitor 7 and the camera monitor 17. After the touch panel operation is performed at a certain time point, the clipped image generated by clipping a part of the input frame image is displayed on the TV monitor 7 (it is also possible to display the clipped image on the camera monitor 17). An operation of the track processing unit 63 and the like from a start point of the input frame image Fₙ supplied to the clip processing unit 62 and the track processing unit 63 right after the touch panel operation will be described.

Right after the touch panel operation, the clip setting unit 61 generates clipping information according to the touch panel operation and supplies the same to the clip processing unit 62. Thus, right after the touch panel operation, the enlarged image of the image in the clipping frame set on the input frame image Fₙ is displayed as the clipped image on the TV monitor 7. A position and a size of the clipping frame set on the input frame image Fₙ is determined on the basis of the touch operation information without depending on an output of the track processing unit 63. After that, positions and sizes of clipping frames set on input frame images Fₙ₊₁, Fₙ₊₂ and so on may be the same as those of the input frame image Fₙ. In this embodiment, however, positions and sizes of them are updated on the basis of the output of the track processing unit 63 (i.e., the track result information).

In order to realize this update, after the touch panel operation, the track processing unit 63 performs a track process of tracking on the input frame image sequence a target object in the input frame image sequence on the basis of the image data of the input frame image sequence. Here, the input frame image sequence is an input frame image sequence constituted of an input frame image Fₙ and individual input frame images after the input frame image Fₙ. If the reproduction target image is a one that is obtained by photographing by the digital camera 1, the target object is a target subject of the digital camera 1 when the reproduction target image is photographed. The target object to be tracked by the track process is referred to as a tracking target in the following description.

In the track process, positions and sizes of the tracking target in the individual input frame images are sequentially detected on the basis of the image data of the input frame image sequence. Actually, an image area (in other words, an image region) in which image data indicating the tracking target exists is set as a tracking target region in each input frame image, and a center position (or a barycenter position) and a size of the tracking target region are detected as a position and a size of the tracking target. The track processing unit 63 outputs the track result information containing information indicating a position and a size of the tracking target in each input frame image. As a method of the track process, any tracking method including known methods can be used. For instance, a mean shift method, a block matching method, or a tracking method based on an optical flow maybe used for realizing the track process.

The clip setting unit 61 updates the clipping information on the basis of the track result information so that the tracking target region is included in the clipping frame set in each input frame image after the input frame image Fₙ. Simply, for example, the clipping information are sequentially updated on the basis of the track result information so that the center of the tracking target region and the center of the clipping frame agree or substantially agree with each other. The size of the clipping frame may be constant, but the size of the clipping frame may be updated in accordance with a size of the tracking target region.

If it becomes unable to detect the tracking target from the input frame image because the tracking target goes out of the frame, the clipping control should be canceled. The clipping control means control of generating the clipped image so as to display the clipped image on the TV monitor 7 and/or the camera monitor 17. Cancel of the clipping control means to cease the generation of the clipped image and the display of the clipped image on the TV monitor 7 and/or the camera monitor 17. After the clipping control is canceled, the entire image of the input frame image is displayed on the TV monitor 7 and the camera monitor 17.

In addition, the clipping control may be canceled also in the case where it is decided that the tracking target has not moved for a predetermined time after the tracking target is set. It is because that if the non-moving object is displayed in an enlarged manner continuously, the display moving image may become monotonous so that the viewer may be bored. If a level of movement of the center position of the tracking target region in the input frame image is lower than a predetermined value for a predetermined time, it is possible to decide that the tracking target has not moved for a predetermined time.

Various methods may be used as a setting method of the tracking target.

For instance, a contour extracting process based on the image data can be used for extracting an object that exists at the center or the vicinity thereof in the clipping frame set in the image Fₙ so as to set the extracted object as a tracking target.

Alternatively, for example, it is also possible to determine a main color of the image inside the clipping frame on the image Fₙ on the basis of image data of the image inside the clipping frame on the image Fₙ, so as to set an object having the main color inside the clipping frame on the image Fₙ as the tracking target. A barycenter of the image area having the main color in the clipping frame on the image Fₙ can be set as the center of the tracking target region, and the image area having the main color can be set as the tracking target region. The main color means, for example, a dominate color or a most frequent color in the image in the clipping frame on the image Fₙ. The dominate color in an image means the color that occupies most part of the image area of the image. The most frequent color in an image means the color that has a highest frequency in a color histogram of the image (the dominate color and the most frequent color may be the same).

Alternatively, for example, it is possible to detect a face of a person existing in the image on the basis of the image data of the image in the clipping frame on the image Fₙ, so as to set the detected face or the person having the same as the tracking target.

Still alternatively, for example, it is also possible to set the tracking target on the basis of the touch operation information generated by the touch panel operation. For instance, it is possible to set an object existing at a position on the display screen 51 touched first by a finger in the touch panel operation as the tracking target.

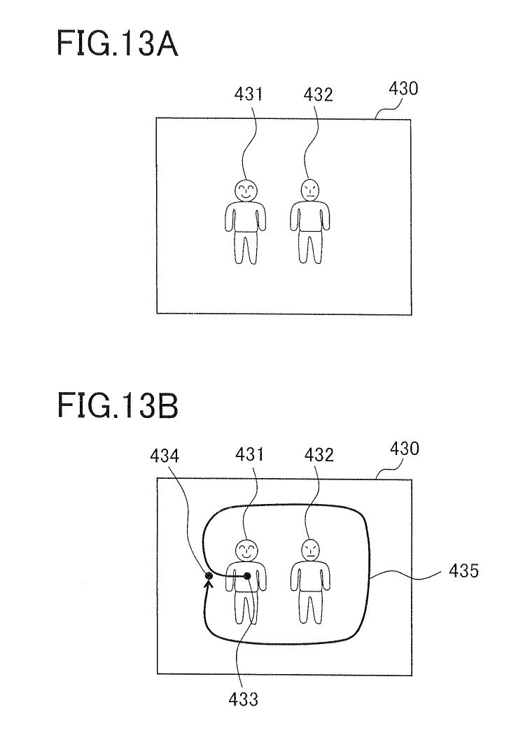

Specifically, for example, it is also possible to use the following tracking target setting method based on the touch panel operation. A case where the input frame image displayed on the camera monitor 17 when the touch panel operation is made is the image 430 illustrated in FIG. 13A will be exemplified. In the image 430, there are image data of persons 431 and 432. If the operator wants to display an enlarged image of the persons 431 and 432 and to set the person 431 as the tracking target, the operator moves a finger in the touch panel operation along a locus 435 from an initial point 433 to a terminal point 434 on the display screen 51 as illustrated in FIG. 13B.

This touch panel operation is a variation of that according to the third operation method described above in the first embodiment (see FIG. 11), in which positions of the points 433 and 434 correspond to positions (x_{3A},y_{3A}) and (x_{3B},y_{3B}), respectively, described above in the third operation method. As described above in the first embodiment, the clip setting unit 61 sets the clipping information temporarily on the basis of the movement locus 435 of the finger specified by the touch operation information so that the barycenter of the figure enclosed by the movement locus 435 is the center of the clipping frame and that the size of the clipping frame corresponds to a size of the figure enclosed by the movement locus 435. On the other hand, the track processing unit 63 sets the object existing at the position (x_{3A},y_{3A}) of the point 433 (the person 431 in this example) is set as the tracking target. After that, as described above, a position and the like of the clipping frame is updated on the basis of a result of the track process.

By updating the position and the like of the clipping frame by using the track process, it is possible to display continuously the enlarged image of the object noted by the operator (and viewer).

### Third Embodiment

A third embodiment of the present invention will be described. Also in the third embodiment, similarly to the second embodiment, it is an assumption that the reproduction target image as the input image is a moving image, and it is supposed that the number of pixels in the display screen of the TV monitor 7 is larger than the number of pixels of the image in the clipping frame.

In the third embodiment, after a position and the like of the clipping frame is determined by the touch panel operation, cancellation or the like of the clipping control is performed as needed on the basis of the camera motion information from the camera motion decision unit 21 illustrated in FIG. 9.

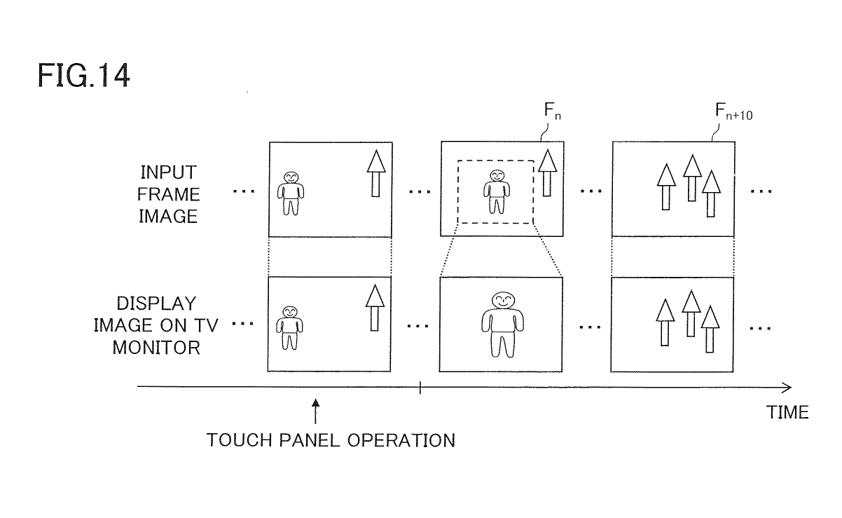

With reference to FIG. 14, a specific operational example will be described. When reproduction of the reproduction target image is started, input frame images that are sequentially read from the recording medium 15 is supplied to the clip processing unit 62 illustrated in FIG. 9. The individual input frame images are supplied also to the camera motion decision unit 21. Before the touch panel operation is performed for setting the clipping information, the entire image of the input frame image is displayed on the TV monitor 7 and the camera monitor 17. When the touch panel operation is performed at a certain time point, the clipped image generated by clipping a part of the input frame image is display on the TV monitor 7 after that (it is also possible to display the clipped image on the camera monitor 17). An operation of the camera motion decision unit 21 and the like from a start point of the input frame image Fₙ supplied to the clip processing unit 62 and the camera motion decision unit 21 right after the touch panel operation will be described.

Right after the touch panel operation, the clip setting unit 61 generates clipping information according to the touch panel operation and supplies the same to the clip processing unit 62. Thus, right after the touch panel operation, the enlarged image of the image in the clipping frame set on the input frame image Fₙ is displayed as the clipped image on the TV monitor 7. Similar clipping control is performed also for the individual input frame images after the input frame image Fₙ, but the clipping control can be cancelled on the basis of the camera motion information.

The camera motion decision unit 21 decides a state of the camera movement on the basis of the image data of the input frame image sequence when the input frame image sequence is photographed. Here, the input frame image sequence is an input frame image sequence constituted of the input frame image Fₙ and the individual input frame images after the input frame image Fₙ. The camera movement means a movement of the main casing 2 by a panning operation (operation of turning the main casing 2 in a yawing direction) or the like. There are camera movements including a movement of turning the main casing 2 in a tilting or rolling direction and a movement of moving the main casing 2 in a parallel manner. In the following description, however, for convenience of description, it is supposed that the camera movement is a movement of the main casing 2 by the panning operation.

For instance, the camera motion decision unit 21 estimates presence or absence of the panning operation on the basis of an optical flow between the first and the second frame images detected on the basis of image data of the first and the second frame images that are adjacent in time, so as to decide presence or absence of the camera movement. The method of estimating presence or absence of the panning operation on the basis of the optical flow is known. The first and second frame image is, for example, the input frame image Fₙ₊₉ and the input frame image Fₙ₊₁₀. If it is estimated that there is a panning operation, it is decided that there is a camera movement. If it is estimated that there is no panning operation, it is decided that there is no camera movement.

In addition, for example, the camera motion decision unit 21 can decide presence or absence of a camera movement by using scene change decision using color histograms. For instance, color histograms of the first and the second frame images are generated from image data of the first and the second frame images (e.g., images Fₙ₊₉ and Fₙ₊₁₀), and a difference degree of the color histogram between the first and the second frame images is calculated. Further, if the difference degree is relatively large, it is decided that there is a camera movement. If the difference degree is relatively small, it is decided that there is no camera movement. If an image of a scene of sea is taken by the panning operation after taking an image of a mountain landscape, the color histogram changes largely between before and after the panning operation. From this change of the color histogram, presence or absence of the camera movement can be decided.

Further, if a camera movement sensor for detecting a movement of the main casing 2 is provided to the camera motion decision unit 21 and detection data of the camera movement sensor is recorded in the recording medium 15 when the input frame image sequence is taken, it is possible to detect presence or absence of a panning operation from the detection data so as to decide presence or absence of the camera movement. The camera movement sensor is, for example, an angular velocity sensor for detecting angular velocity of the main casing 2 or an acceleration sensor for detecting acceleration of the main casing 2.

If it is decided there is a camera movement while the clipping control is performed, the clip setting unit 61 and the clip processing unit 62 cancel the clipping control at the decision time point. For instance, if the panning operation is performed in the time period between the input frame images Fₙ₊₉ and Fₙ₊₁₀ and it is decided that there is a camera movement between the input frame images Fₙ₊₉ and Fₙ₊₁₀, the clipping control for the input frame image Fₙ₊₁₀ is canceled so that the entire image of the input frame image Fₙ₊₁₀ is displayed on the TV monitor 7 (and the camera monitor 17) (see FIG. 14). Unless a touch panel operation is performed again, the clipping control is not performed for the individual input frame images after the input frame image Fₙ₊₁₀.

However, after the clipping control is once cancelled, it is also possible to process as follows. It is supposed that the first panning operation has been performed between the input frame images Fₙ₊₉ and Fₙ₊₁₀, and due to this, the clipping control that has been performed for the input frame images Fₙ to Fₙ₊₉ is cancelled at the time point of displaying the input frame image Fₙ₊₁₀. In this case, the camera motion decision unit 21 stores the clipping information set for the input frame image Fₙ₊₉ that is a taken image before the first panning operation as initial clipping information. Then, after the input frame image Fₙ₊₉ is regarded as a background image, similarity between each input frame image (Fₙ₊₁₁, Fₙ₊₁₂ and so on) obtained after the input frame image Fₙ₊₁₀ and the background image is evaluated. When an input frame image giving high similarity is supplied to the camera motion decision unit 21, the clipping control is restarted by using the initial clipping information.

More specifically, for example, a binary differential image between the input frame image and the background image is generated for each input frame image obtained after the input frame image Fₙ₊₁₀, so that the similarity between the input frame image and the background image is evaluated from the binary differential image. If a sum of absolute values of pixel signals of individual pixels of the binary differential image is smaller, the similarity is higher. The clipping control is not restarted until a similarity higher than a predetermined reference similarity is obtained. For instance, if similarities corresponding to input frame images Fₙ₊₁₁ to Fₙ₊₁₉ are lower than the reference similarity and a similarity corresponding to the input frame image Fₙ₊₂₀ is higher than the reference similarity, it is decided that the second panning operation is performed right before the input frame image Fₙ₊₂₀ is taken, so that the imaging direction of the digital camera 1 is reset to that before the first panning operation, and the clipping control is restarted. The initial clipping information is applied to the input frame images (including the input frame image Fₙ₊₂₀) after the clipping control is restarted.

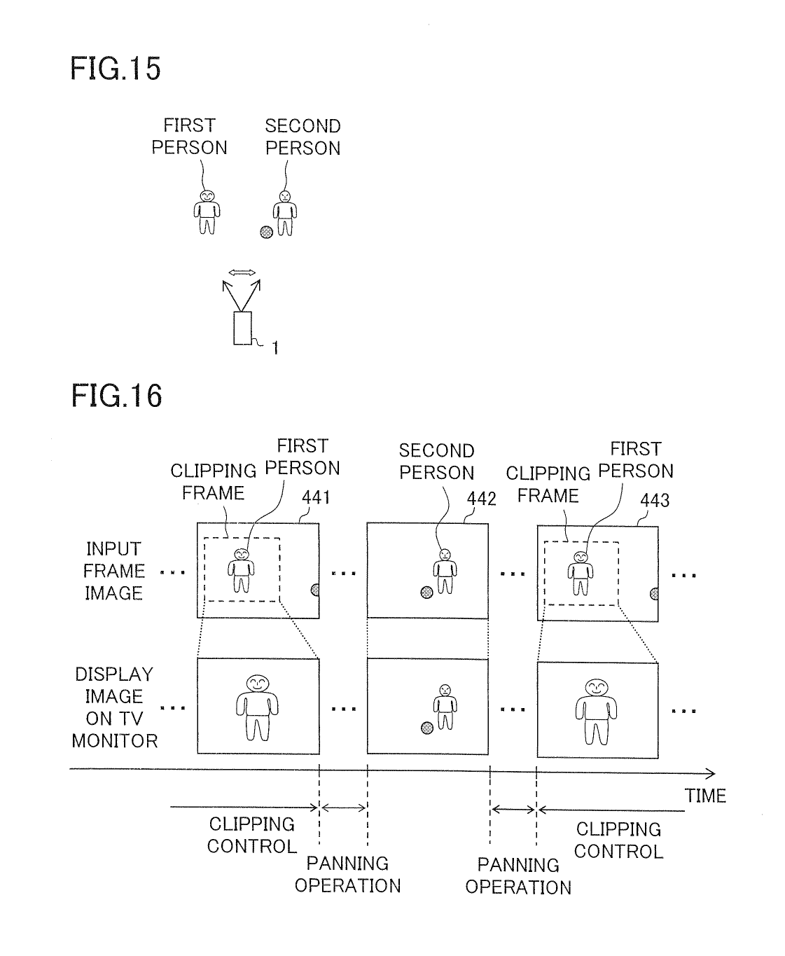

This method can be adapted to a situation, for example, as illustrated in FIGS. 15 and 16, after taking images with a composition in which a first person is noted (composition corresponding to an image 441 illustrated in FIG. 16) for a while, a first panning operation is performed so as to take an image with another composition in which a second person is noted (composition corresponding to an image 442 illustrated in FIG. 16), and after that, a second panning operation is performed so as to reset a photography composition to the composition in which the first person is noted (composition corresponding to an image 443 illustrated in FIG. 16).

Note that it is possible to restart the clipping control on the basis of the initial clipping information according to an instruction from the operator. For instance, in the above-mentioned example, after the clipping control is cancelled by the first panning operation, the initial clipping information is stored while the entire images of the individual input frame images after the input frame image Fₙ₊₁₀ are sequentially displayed on the TV monitor 7 and the camera monitor 17. In this case, a particular icon is also displayed on the display screen 51 of the camera monitor 17. When the operator touches the icon with a finger, the initial clipping information is applied to the input frame images after the time point of the touching operation, and the clipping control is restarted.

If the clipping control is simply continued when the panning operation or the like is performed, it is usually undesired because an image area that is not noted by the operator and viewer is enlarged and displayed. This problem can be solved by the method of the third embodiment.

### Fourth Embodiment

A fourth embodiment of the present invention will be described. In the fourth embodiment, a timing when the touch panel operation is reflected on the display image will be described. Operations performed by the operator to the digital camera 1 for displaying a desired image on the TV monitor 7 or the camera monitor 17 include the above-mentioned touch panel operation and other setting operation. A series of periods of the touch panel operation and the setting operation is referred to as an operation period. The operation period can be considered to start at the same time when the touch panel operation is started. However, it is possible to start the operation period by a predetermined operation operated by the operator. The operation period may be finished simultaneously with the end of the touch panel operation (i.e., the operation period may be finished when the finger is released from the display screen 51), or the operation period may be finished in accordance with a predetermined operation performed by the operator.

In a first method, when the touch panel operation is started, the clipped image is promptly displayed on the TV monitor 7 or the camera monitor 17 in accordance with the touch panel operation without waiting the end of the operation period. More specifically, for example, in the case where the above-mentioned first operation method is used (see FIG. 11), it is supposed that the operator pushes a point on the display screen 51 with a finger for Δt seconds, and then releases the finger from the display screen 51. A size of the clipping frame corresponding to the At seconds is represented by SIZE[Δt]. In this case, when the operator pushes a point on the display screen 51 with a finger for Δt/3 seconds, the clipping frame having a size of SIZE[Δt/3] is set so as to perform the clipping control. After that, when Δt/3 seconds further past, the clipping frame having a size of SIZE[2Δt/3] is set so as to perform the clipping control. After that, when Δt/3 seconds further past, the clipping frame having a size of SIZE[Δt] is set so as to perform the clipping control. Here, SIZE[Δt]<SIZE[2Δt/3]<SIZE[Δt/3] is satisfied. In this way, without waiting completion of the touch panel operation, the display image changes sequentially.

In a second method, until the touch panel operation is completed, or until the operation period is finished, a result of the touch panel operation is not reflected on the display image. For instance, when the first operation method is utilized (see FIG. 11), if the operator releases the finger from the display screen 51 after pushing a point on the display screen 51 with the finger for Δt seconds, the clipping control is not performed until the finger is released from the display screen 51. The clipping control may be performed after the finger is released so as to finish the operation period.

### Fifth Embodiment

A fifth embodiment of the present invention will be described. In the fifth embodiment, display content control of the camera monitor 17 or the TV monitor 7 during the operation period will be described. As a display content control method, first to fifth display control methods are described as follows. In the digital camera 1, any one of the first to the fifth display control method can be performed. It is possible to combine one display control method with another display control method to be performed, as long as no contradiction arises.

The first display control method will be described. In the first and the second display control methods, it is an assumption that the clipped image is displayed on the camera monitor 17 after the clipping information is generated. In the first display control method, the contents of the touch panel operation are promptly reflected on the camera monitor 17. Specifically, when the touch panel operation is performed, the clipped image according to the clipping information corresponding to the touch panel operation is promptly generated from the input image and is displayed on the camera monitor 17 (in other words, when the touch panel operation is performed for specifying a position and a size of the clipping frame, the specified contents is promptly reflected on the display contents of the camera monitor 17). In the first display control method, the response of changing display contents according to the touch panel operation can be improved.

A second display control method will be described. In the second display control method, the contents of the touch panel operation performed during the operation period are reflected on the camera monitor 17 step by step (in other words, when the touch panel operation for specifying a position and a size of the clipping frame is performed, the specified contents are reflected on the display contents of the camera monitor 17 step by step). For instance, it is supposed that a size of the clipping frame is set to ⅓ of that of the input image by the touch panel operation from an initial state in which the entire image of the input image is displayed on the camera monitor 17. In this case, right after the touch panel operation, the clipped image using the clipping frame having a size of ⅔ of the input image is displayed on the camera monitor 17. Then, after a predetermined time passes, the clipped image using the clipping frame having a size of ½ of the input image is displayed on the camera monitor 17. Further, after a predetermined time passes, the clipped image using the clipping frame having a size of ⅓ of the input image is displayed on the camera monitor 17. The center position of each clipping frame agrees with that specified by the touch panel operation. According to the second display control method, a result of the touch panel operation is gently reflected on the image, so that the operator can easily set the display image to a desired one.

A third display control method will be described. In the third display control method, it is an assumption that the entire image of the reproduction target image is displayed on the camera monitor 17 during the operation period. In the third display control method, the clipping frame is actually displayed on the camera monitor 17 during the operation period. Specifically, for example, if the reproduction target image supplied to the clip processing unit 62 is the reproduction target image 310 illustrated in FIG. 8A, the clip processing unit 62 displays on the camera monitor 17 the reproduction target image 310 on which the clipping frame 311 is superposed during the operation period. Since the clipping frame is displayed on the camera monitor 17, the operator can easily set the display image to a desired one.

A fourth display control method will be described. In the fourth display control method, clip setting information is displayed only on the camera monitor 17. The clip setting information means information for supporting the operator to determining a position and the like of the clipping frame.

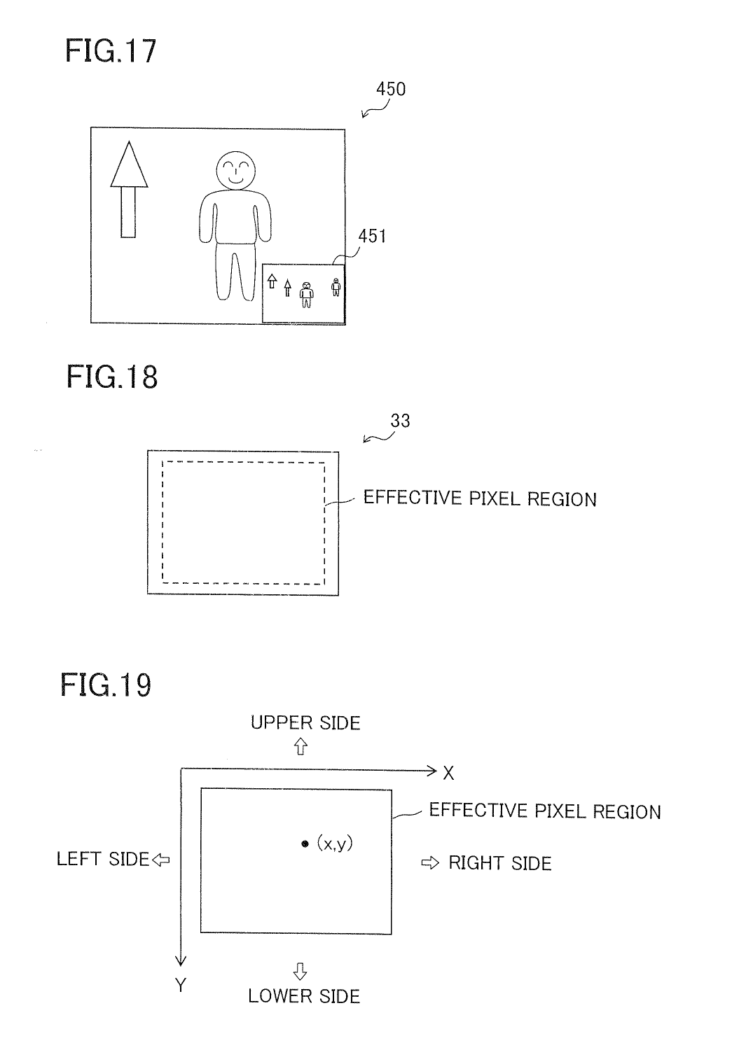

In the fourth display control method, for example, an image 450 as illustrated in FIG. 17 can be displayed on the camera monitor 17 during the operation period. The image 450 is a one in which an image 451 that is a reduced image of the reproduction target image 310 illustrated in FIG. 8A is superposed on the clipped image 320 illustrated in FIG. 8B at an end. The image 451 corresponds to the clip setting information. In the camera monitor 17, it is possible to display further the clipping frame on the image 451. When the image 450 is displayed on the camera monitor 17, the reproduction target image 310 is displayed on the TV monitor 7 illustrated in FIG. 8A, for example. After the operation period is finished, the clipped image 320 illustrated in FIG. 8B is displayed. In this way, the clip setting information is not displayed on the TV monitor 7. Therefore, abnormal feeling or unpleasant feeling of the viewer of the TV monitor 7 due to displaying the clip setting information on the TV monitor 7 is not generated.

The clip setting information is not limited to that described above. The clipping frame displayed on the camera monitor 17 as described above in the third display control method is also one type of the clip setting information. In addition, it is possible that numeric value or the like indicating a position or a clipping size of the clipping frame is included in the clip setting information. In addition, it is also possible to display any icon to support setting of the clipping frame (e.g., the icon described above in the third embodiment) as the clip setting information on the camera monitor 17.

Further, it is also possible to perform the display according to the third or the fourth display control method at time other than the operation period. For instance, it is possible to display on the camera monitor 17 the entire image of the reproduction target image on which the clipping frame is superposed or an image such as the image 450 illustrated in FIG. 17 regardless of whether or not the present time belongs to the operation period.

A fifth display control method will be described. In the fifth display control method, it is assumption that the reproduction target image is a moving image. In the case where the reproduction target image is a moving image, after the touch panel operation, the clipped images are sequentially generated from the frame images constituting the reproduction target image so that the moving image constituted of the clipped image sequence is displayed on the TV monitor 7. In addition, the moving image constituted of the clipped image sequence or the moving image constituted of the frame image sequence (i.e., the reproduction target image) is displayed on the camera monitor 17. In the fifth display control method, during the operation period, reproduction of the moving image displayed on the camera monitor 17 is temporarily stopped. Specifically, for example, the image displayed on the camera monitor 17 at start time of the operation period (a clipped image or a frame image as a still image) is displayed fixedly on the camera monitor 17 during the operation period. By temporarily stopping the reproduction of the moving image, the operator can easily perform various operations. When the operation period is finished, the reproduction of the moving image to be displayed on the camera monitor 17 is restarted.

In each display control method described above, display contents of the camera monitor 17 are particularly noted, but it is possible to display on the TV monitor 7 a whole or a part of the display contents of the camera monitor 17 described above in each display control method described above, as long as no contradiction arises.

### Sixth Embodiment

A sixth embodiment of the present invention will be described. A display content control of the TV monitor 7 after finishing the operation period will be described. As a display content control method according to the sixth embodiment, the sixth and the seventh display control method will be described later. In the digital camera 1, the sixth or the seventh display control method can be performed.

A sixth display control method will be described. In the sixth and the seventh display control methods, it is an assumption that the contents of the touch panel operation performed during the operation period is not reflected on the TV monitor 7 in the operation period. In the sixth display control method, the contents of the touch panel operation performed during the operation period is promptly reflected on the TV monitor 7 right after the operation period is finished. In other words, display of the clipped image corresponding to the touch panel operation is not performed on the TV monitor 7 during the operation period, but when the operation period is finished, right after that, the clipped image based on the clipping information corresponding to the touch panel operation is promptly generated from the reproduction target image and is displayed on the TV monitor 7. According to the sixth display control method, the response of changing display contents according to the touch panel operation can be improved.

A seventh display control method will be described. In the seventh display control method, the contents of the touch panel operation performed during the operation period is reflected step by step on the TV monitor 7 right after the operation period is finished. For instance, it is supposed that a size of the clipping frame is set to ⅓ of that the input image by the touch panel operation from an initial state in which the entire image of the input image is displayed on the camera monitor 17. In this case, right after the touch panel operation, the clipped image using the clipping frame having a size of ⅔ of the input image is displayed on the TV monitor 7. Then, after a predetermined time passes, the clipped image using the clipping frame having a size of ½ of the input image is displayed on the TV monitor 7. Further, after a predetermined time passes, the clipped image using the clipping frame having a size of ⅓ of the input image is displayed on the TV monitor 7. The center position of each clipping frame agrees with that specified by the touch panel operation. According to the seventh display control method, a relationship between display images before and after the clipping control is performed can be easily understood by the viewer.

It is possible to combine any one of the first to the fifth operation methods described above in the first embodiment with any method described above in the second to the sixth embodiments.

### Seventh Embodiment

A seventh embodiment of the present invention will be described. In the above description, a still image or a moving image taken in the imaging mode is temporarily recorded in the recording medium 15, and after that, in the reproducing mode, the still image or the moving image read from the recording medium 15 is supplied to the clip processing unit 62 as the input image. In contrast, in the seventh embodiment, the process of generating a still image or a moving image of clipped images from the still image or the moving image obtained by photography is performed in real time in the imaging mode. Note that as to the digital camera 1 according to the seventh embodiment, the clip setting unit 61 and the clip processing unit 62 illustrated in FIG. 9 are disposed not in the display controller 20 but in the image processing unit 14.

An operation when a still image is taken in the imaging mode will be described. When a still image is taken in the imaging mode, one frame image indicating the still image is displayed on the camera monitor 17 and is supplied to the clip processing unit 62 illustrated in FIG. 9 as the input image. In the state where the entire image of the input image is displayed on the camera monitor 17, a photographer can perform the same touch panel operation as that described above. When the touch panel operation is performed to the camera monitor 17, the clip setting unit 61 generates the clipping information on the basis of the touch operation information based on the touch panel operation, and the clip processing unit 62 generates the clipped image from the still image as the input image in accordance with the clipping information. The touch panel operation method and the method of generating the clipped image from the input image in accordance with the touch panel operation are the same as those described above.

After the clipped image is generated, the display controller 20 can display the clipped image on the camera monitor 17 (or the TV monitor 7). In addition, the image data of the clipped image can be recorded in the recording medium 15. It is possible to record also the entire image data of the input image together with the image data of the clipped image in the recording medium 15.

An operation when the moving image is taken in the imaging mode will be described. When the moving image is taken, in the imaging mode, the individual frame images forming the moving image are sequentially displayed on the camera monitor 17 and are supplied as the input frame image to the clip processing unit 62 illustrated in FIG. 9. In the state where the entire image of the input frame image is displayed on the camera monitor 17, the photographer can perform the same touch panel operation as that described above. When the touch panel operation is performed to the camera monitor 17, the clip setting unit 61 generates the clipping information on the basis of the touch operation information based on the touch panel operation, and the clip processing unit 62 generates the clipped image from each input frame image in accordance with the clipping information. The touch panel operation method and the method of generating the clipped image from the input image in accordance with the touch panel operation are the same as those described above.

The display controller 20 can display the clipped image sequence generated from the input frame image sequence on the camera monitor 17 (or the TV monitor 7). In addition, the image data of the clipped image sequence can be recorded on the recording medium 15. Together with the image data of the clipped image sequence, the entire image data of the input frame image sequence may also be recorded in the recording medium 15.

In addition, when a moving image is photographed, the image data of each input frame image may also be supplied to the track processing unit 63 and/or the camera motion decision unit 21 illustrated in FIG. 9. Thus, it is also possible to perform clipping control based on not only the touch operation information but also the track result information and/or the camera motion information.

The seventh embodiment is an embodiment based on the description in the first embodiment, and the description in the first embodiment can also be applied to the seventh embodiment as long as no contradiction arises. Further, the descriptions in the second to the sixth embodiments can also be applied to the seventh embodiment as long as no contradiction arises. When the descriptions in the first to the sixth embodiments are applied to the seventh embodiment, some terms adapted to the reproducing mode should be read as another term adapted to the imaging mode. Specifically, for example, when the descriptions in the first to the sixth embodiments are applied to the seventh embodiment, “operator” and “reproduction target image” in the descriptions in the first to the sixth embodiments should be read as “photographer” and “record target image” (or simply “target image”), respectively.

Further, the image sensor 33 illustrated in FIG. 3 is formed of a plurality of light receiving pixels arranged in a two-dimensional manner, and as illustrated in FIG. 18, a rectangular effective pixel region is set in the entire region in which the light receiving pixels are arranged. Each of the light receiving pixels performs photoelectric conversion of an optical image of a subject entering through the optical system 35 and the aperture stop 32, so as to output an electric signal obtained by the photoelectric conversion as the image signal. As illustrated in FIG. 19, the effective pixel region is also recognized as a region on the XY coordinate plane similarly to the display screen 51 and the two-dimensional image 300 (see FIGS. 6A and 6B), and a position in the effective pixel region is expressed as a position (x,y) on the XY coordinate plane. The image signal at the position (x,y) in the effective pixel region becomes the image signal at the position (x,y) on the frame image.

The entire image of the frame image is formed of the output image signal of the individual light receiving pixels arranged in the effective pixel region. Since the clipped image is a part of the entire image of the frame image, the clipped image is formed of the output image signal of light receiving pixels in a part of the effective pixel region. The region where a part of the light receiving pixels are arranged can be regarded as the clipping region on the image sensor 33. The clipping region on the image sensor 33 is a part of the effective pixel region. Then, it can be said that the clip processing unit 62 is a unit of extracting the output image signal of the light receiving pixels in the clipping region set on the effective pixel region.

Considering this, when a moving image is taken, after the clipping information is set, it is possible to define a clipping region (clipping frame) according to the clipping information on the image sensor 33 so as to read only the output image signal of the light receiving pixels in the clipping region from the image sensor 33. Here, the image formed of the read image signal is equivalent to the clipped image described above, and this image may be displayed as the output image on the camera monitor 17 (or the TV monitor 7) and may be recorded in the recording medium 15.

In this embodiment too, the same effect as that of the embodiments described above can be obtained. Specifically, since the clipping position and size can be specified by an intuitive touch panel operation (region specifying operation), the operator can set an angle of view and the like of the display image or the record image to desired ones quickly and easily.

### Eighth Embodiment

An eighth embodiment of the present invention will be described. As a method of extracting a subject image in a particular region, the method using so-called electronic zoom is described above in the seventh embodiment, while in the eighth embodiment, a method using optical zoom will be described. The following description in the eighth embodiment is a description of an operation of the digital camera 1 in the imaging mode.

In the imaging mode, the frame image sequence obtained by sequential photography is displayed as a moving image on the camera monitor 17 under control of the display controller 20. In the eighth embodiment, the image displayed on the camera monitor 17 is the entire image of the frame image. In the state where the entire image of the frame image is displayed on the camera monitor 17, the photographer can perform the same touch panel operation as that described above. When the touch panel operation is performed to the camera monitor 17, the clip setting unit 61 illustrated in FIG. 9 generates the clipping information on the basis of the touch operation information based on the touch panel operation. In the digital camera 1 according to the eighth embodiment, the clip setting unit 61 is disposed in the photography control unit 13 illustrated in FIG. 2.

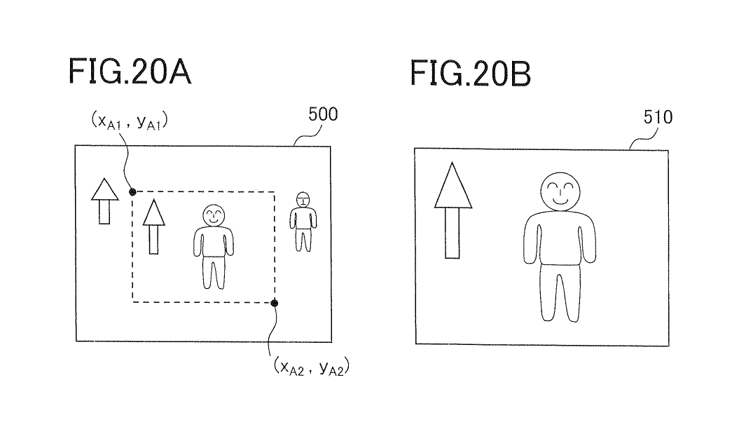

In the eighth embodiment, a frame corresponding to the clipping frame described above in each embodiment is referred to as an expansion specifying frame. Now, for specific description, it is supposed that when a frame image 500 illustrated in FIG. 20A is displayed on the camera monitor 17, positions of the upper left corner and the lower right corner of the expansion specifying frame, which are (x_{A1},y_{A1}) and (x_{A2},y_{A2}), respectively, are specified by the touch panel operation performed by the operator to the camera monitor 17. In addition, for simple description, it is supposed that each subject and the digital camera 1 are still in real space and that an aspect ratio of the expansion specifying frame is the same as the aspect ratio of the effective pixel region.

In this case, the photography control unit 13 adjusts the imaging angle of view and adjusts an incident position of the optical image of the subject on the image sensor 33, on the basis of the clipping information to be said as expansion specifying information, so that the optical images of the subjects that have been formed at positions (x_{A1},y_{A1}) and (x_{A2},y_{A2}) on the image sensor 33 when the frame image 500 is taken are formed at the upper left corner and the lower right corner in the effective pixel region after a time period necessary for optical control passes. The adjustment of the imaging angle of view is realized by movement of the zoom lens 30 illustrated in FIG. 3, and the adjustment of the incident position is realized by the movement of the correction lens 36 illustrated in FIG. 3. The time period necessary for optical control means a time period necessary for the adjustment of the imaging angle of view and the adjustment of the incident position.

A frame image 510 obtained by photography after the time period necessary for optical control passes is illustrated in FIG. 20B. The frame image 510 is also formed of the output image signal of the light receiving pixels arranged in the effective pixel region, similarly to the frame image 500.

The photography control unit 13 can realize the above-mentioned optical control as described later. The movement direction and the movement amount of the correction lens 36 that is necessary for forming the optical image of the subject that has been formed at the center position ((x_{A1}+x_{A2})/2,(y_{A1}+y_{A2})/2) of the expansion specifying frame, at the center position of the effective pixel region are determined by using a lookup table or a conversion expression that is prepared in advance. In addition, a ratio of a size (width or height) of the effective pixel region to a size (width or height) of the expansion specifying frame is determined, while a ratio of an imaging angle of view when the frame image 500 is taken to an imaging angle of view when the frame image 510 is taken is determined. Then, the movement amount of the zoom lens 30 necessary for matching the former ratio with the latter ratio is determined by using a lookup table or a conversion expression that is prepared in advance (the movement direction of the zoom lens 30 is known). Then, in the period after photography of the frame image 500 is finished until the exposure of the frame image 510 is started, the correction lens 36 is actually moved in accordance with the determined movement direction and movement amount of the correction lens 36, and the zoom lens 30 is actually moved in accordance with the determined movement amount of the zoom lens 30. Thus, the above-mentioned optical control is realized.

The display controller 20 can display each of the frame images 500 and 510 as a still image on the camera monitor 17 (and the TV monitor 7), and can display the frame image sequence including the frame images 500 and 510 as a moving image on the camera monitor 17 (and the TV monitor 7). The record controller 16 can record each of the frame images 500 and 510 as a still image in the recording medium 15, and can record the frame image sequence including the frame images 500 and 510 as a moving image in the recording medium 15.

The eighth embodiment is an embodiment based on the description in the first embodiment, and the description in the first embodiment can also be applied to the eighth embodiment as long as no contradiction arises. Further, the descriptions in the second to the seventh embodiments can also be applied to the eighth embodiment as long as no contradiction arises. When the descriptions in the first to the sixth embodiments are applied to the eighth embodiment, some terms adapted to the reproducing mode should be read as another term adapted to the imaging mode. Specifically, for example, when the descriptions in the first to the sixth embodiments are applied to the eighth embodiment, “operator” in the descriptions in the first to the sixth embodiments should be read as “photographer”.

In this embodiment too, the same effect as that of the embodiments described above can be obtained. Specifically, since a position and a size of the expansion specifying frame can be specified by an intuitive touch panel operation (view angle and position specifying operation), the operator can set an angle of view and the like of the display image or the record image to desired ones quickly and easily. In addition, since the enlarged image of the target subject is obtained by the optical control, image quality of the display image or the record image is improved compared with the seventh embodiment in which it is obtained by electronic zoom.

The method for realizing the adjustment of the incident position of the optical image by using movement of the correction lens 36 is described above, it is possible to realize the adjustment of the incident position by disposing a variangle prism (not shown) that can adjust a refraction angle of the incident light from the subject instead of the correction lens 36 in the optical system 35 and by driving the variangle prism. Alternatively, instead of driving an optical member such as the correction lens 36 or the variangle prism, it is possible to move the image sensor 33 in the direction perpendicular to the optical axis so as to realize the adjustment of the incident position. The function of driving the variangle prism or the function of moving the image sensor 33 may be performed by the photography control unit 13 illustrated in FIG. 2 that works as an incident position adjustment unit. The photography control unit 13 also has a function as a view angle adjustment unit for adjusting the imaging angle of view. It is also possible to regard that the elements of the incident position adjustment unit and the view angle adjustment unit further include the driver 34.

### Ninth Embodiment

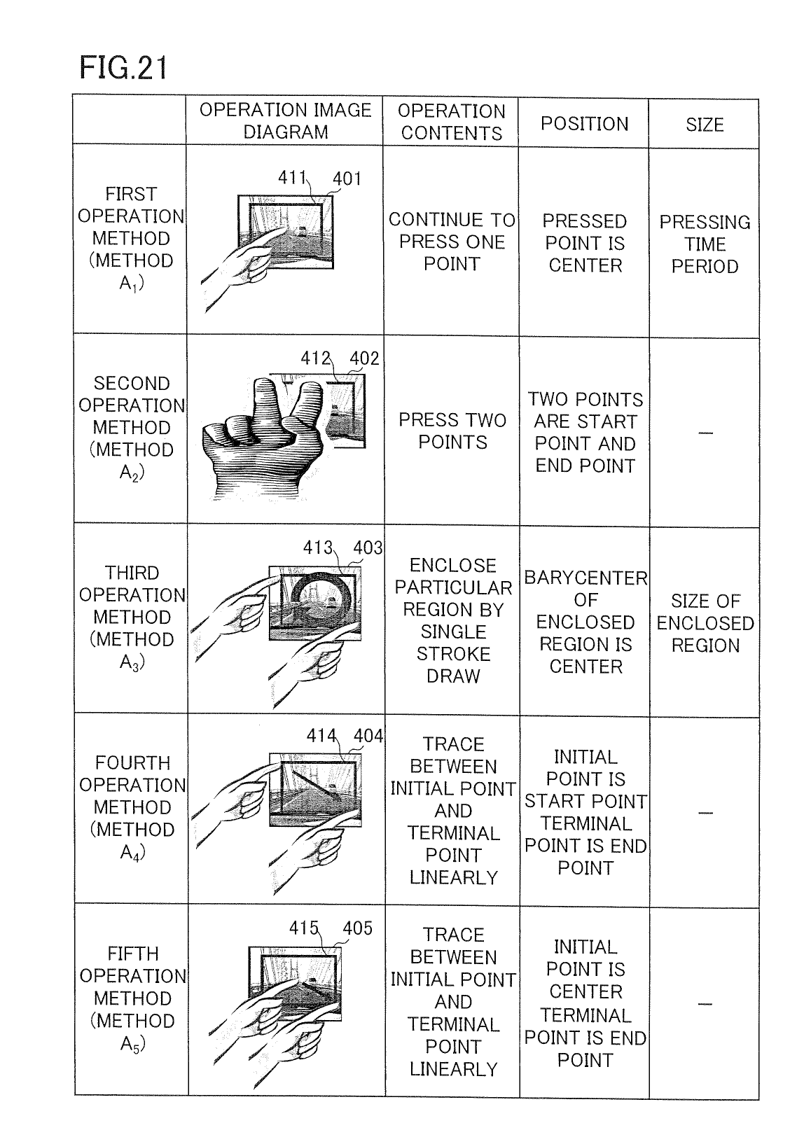

A ninth embodiment of the present invention will be described. The ninth embodiment is an embodiment based on the description in the first embodiment, and as to matters that are not particularly described in this embodiment, the description in the first embodiment is also applied to this embodiment as long as no contradiction arises. Further, descriptions in the second to the sixth embodiments can also be applied to this embodiment as long as no contradiction arises. In the ninth embodiment too, similarly to the first embodiment, an operation of the digital camera 1 in the reproducing mode will be described. In the first embodiment, the first to the fifth operation methods for specifying a position and a size of the clipping frame (e.g., the clipping frame 311 illustrated in FIG. 8A) are described with reference to FIG. 11. In this embodiment and other embodiments described later, for convenience sake, as illustrated in FIG. 21, the first to the fifth operation methods are also referred to as methods A₁ to A₅, respectively. As described above, the image in the clipping frame is displayed as the clipped image. By using the method Aᵢ in the first embodiment, the display image is changed from the reproduction target image 310 illustrated in FIG. 8A to the clipped image 320 illustrated in FIG. 8B, for example. Symbol i denotes any integer. In the following description, unless otherwise described, the display means a display on the TV monitor 7 and the camera monitor 17, and the display image means an image displayed on the TV monitor 7 or the camera monitor 17.

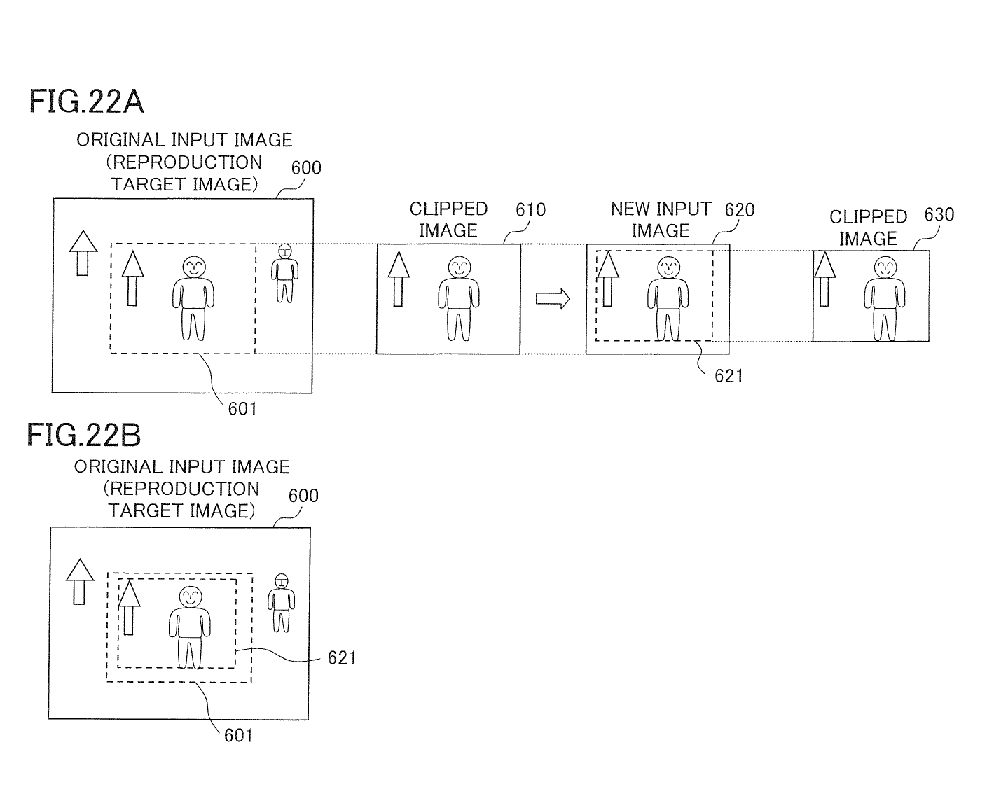

In the following description, the input image that is a reproduction target image itself is also referred to as an original input image, for convenience sake. It is also possible that the clipped image extracted from the original input image by using the method Aᵢ is set as a new input image, and the method Aᵢ is further applied to the new input image. In FIG. 22A, numeral 600 indicates an example of the original input image. The clip setting unit 61 and the clip processing unit 62 illustrated in FIG. 9 can set a clipping frame 601 in the original input image 600 by using the method Aᵢ so as to extract the image in the clipping frame 601 as a clipped image 610. Further, the clip setting unit 61 and the clip processing unit 62 regard the clipped image 610 as a new input image 620 and can set a clipping frame 621 in the input image 620, and can also extract the image in the clipping frame 621 as a clipped image 630. Since the input image 620 is a part of the original input image 600, as illustrated in FIG. 22B, the clipping frame 621 can be regarded as a clipping frame set in the original input image 600.

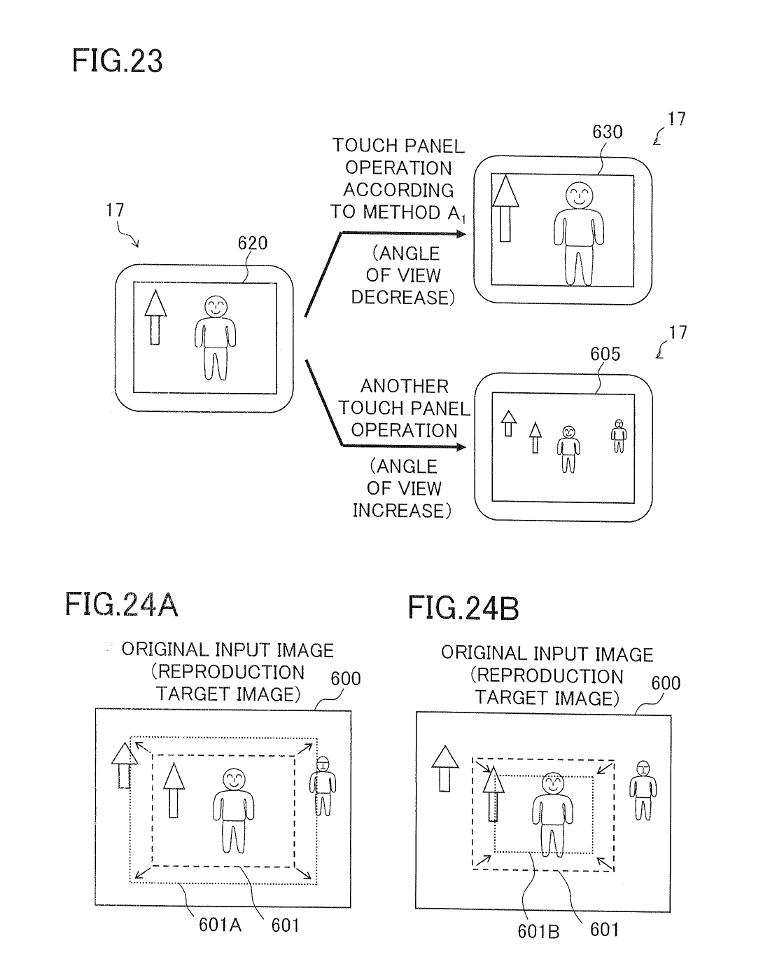

When the touch panel operation according to the method Aᵢ described above is performed, the angle of view of the display image is decreased. By utilizing another touch panel operation, it is also possible to increase the angle of view of the display image. Specifically, for example, as illustrated in FIG. 23, in the state where the input image 620 is displayed on the camera monitor 17 or the like, if the touch panel operation according to the method Aᵢ is performed, the clipping frame is changed from the clipping frame 601 to the clipping frame 621 illustrated in FIG. 22B so that the clipped image 630 is displayed (i.e., the angle of view of the display image is decreased). If the above-mentioned another touch panel operation is performed, the clipping frame is changed to a clipping frame (not shown) that is larger than the clipping frame 601 so that a clipped image 605 having an angle of view larger than that of the input image 620 is displayed (i.e., an angle of view of the display image increases). The clipped image 605 may agree with the original input image 600. The decrease in the angle of view of the display image corresponds to zoom-in of the display image, and the increase in the angle of view of the display image corresponds to zoom-out of the display image.

In this embodiment, a method of increasing and decreasing the angle of view of the display image in a switching manner by the touch panel operation will be described. As apparent from the above description, the decrease in the size of the clipping frame causes a decrease in the angle of view of the display image. The increase in the size of the clipping frame causes an increase in the angle of view of the display image. Therefore, the method of increasing and decreasing the angle of view of the display image in a switching manner can be said to be a method of increasing and decreasing the size of the clipping frame in a switching manner. In the following description, for convenience sake, the state where the clipping frame 601 illustrated in FIG. 22A is set in the original input image 600 so that the input image 620 is displayed is considered as a reference state. Therefore, the increase (i.e., expansion) in a size of the clipping frame means that the clipping frame set on the original input image 600 is changed from the clipping frame 601 to a clipping frame 601 A larger than the clipping frame 601 as illustrated in FIG. 24A. By this change, the image in the clipping frame 601A is generated and displayed as the clipped image. On the contrary, the decrease (i.e., reduction) in a size of the clipping frame means that the clipping frame set on the original input image 600 is changed from the clipping frame 601 to a clipping frame 601B smaller than the clipping frame 601 as illustrated in FIG. 24B. By this change, the image in the clipping frame 601B is generated and displayed as the clipped image. Further, as described in the first embodiment, since a region inside the clipping frame is the clipping region, the size of the clipping frame and the size of the clipping region have the same meaning.

The user can use the touch panel so as to perform the operation of changing the clipping frame set on the original input image 600 from the clipping frame 601 to the clipping frame 601A (hereinafter referred to as an increasing operation) and the operation of changing the clipping frame set on the original input image 600 from the clipping frame 601 to the clipping frame 601B (hereinafter referred to as a decreasing operation). The former change corresponds to the increase (i.e., expansion) in a size of the clipping frame, while the latter change corresponds to the decrease (i.e., reduction) in a size of the clipping frame. Each of the increasing operation and the decreasing operation is one type of the touch panel operation. The touch panel operation according to the method Aᵢ described above in the first embodiment is one type of the decreasing operation. Each of the various methods of increasing a size of the clipping frame as follows is one type of the increasing operation. When a size of the clipping frame is increased in accordance with the increasing operation, the center position of the clipping frame may be agreed before and after the increase, the center position of the clipping frame after the increase may be determined on the basis of the increasing operation (the same is true in other embodiments described later).

—Increase/Decrease Switching Method—

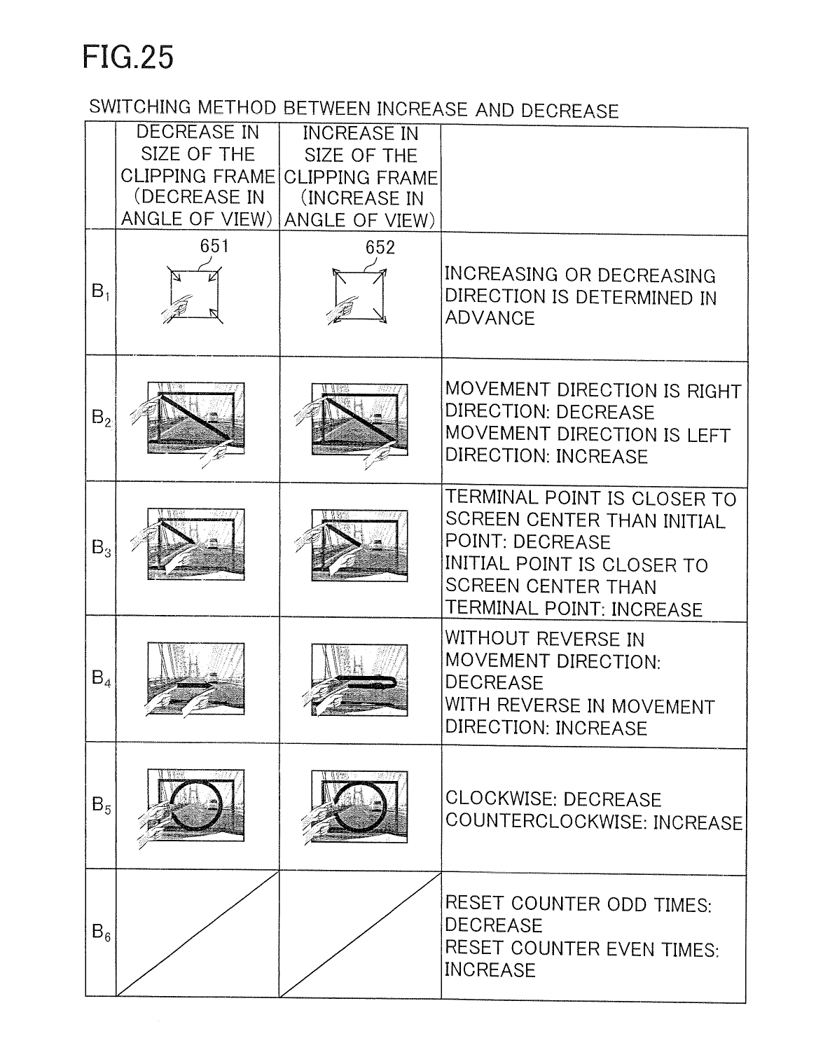

First, as a method of switching between increase and decrease of a size of the clipping frame, a plurality of switching methods will be described. By each of the switching methods, a change direction of a size of the clipping frame is determined. The plurality of switching methods include the following methods B₁ to B₆. FIG. 25 illustrates an outline of the methods B₁ to B₆.

[Method B₁]

In the method B₁, a change direction of a size of the clipping frame is determined in advance by an increasing or decreasing direction setting operation as one type of the touch panel operation or an increasing or decreasing direction setting operation with respect to the operating part 18 illustrated in FIG. 1. If the determined direction is the increase direction, a size of the clipping frame is increased by the following touch panel operation. On the contrary, if the determined direction is the decrease direction, a size of the clipping frame is decreased by the following touch panel operation.

The method B₁ can be performed in combination with any one of the methods A₁ to A₅. For instance, in the case where it is combined with the method A₁, if the determined direction is the decrease direction, a touch position is set to the center so that a size of the clipping frame (clipping frame 651 in the example illustrated in FIG. 25) decreases as the touch time increases. If the determined direction is the increase direction, a touch position is set to the center so that a size of the clipping frame (clipping frame 652 in the example illustrated in FIG. 25) increases as the touch time increases. The touch position means a position on the display screen 51 at which the finger touches the display screen 51. The touch time means a period of time while the finger touches the display screen 51, which is the same as the “pressing time period” described above in the first embodiment.

In the case where the method B₁ is combined with any one of the methods A₂ to A₅, if the determined direction is the decrease direction, the clipping frame should be set in accordance with the methods A₂ to A₅. By this setting, a size of the clipping frame is decreased. In the case where the method B₁ is combined with any one of the methods A₂ to A₅, if the determined direction is the increase direction, a size of the clipping frame should be increased by a predetermined touch panel operation (e.g., an operation of pressing a specific point on the display screen 51 with a finger). A method of setting an increase rate will be described later (the same is true for the methods B₂ to B₆).

[Method B₂]

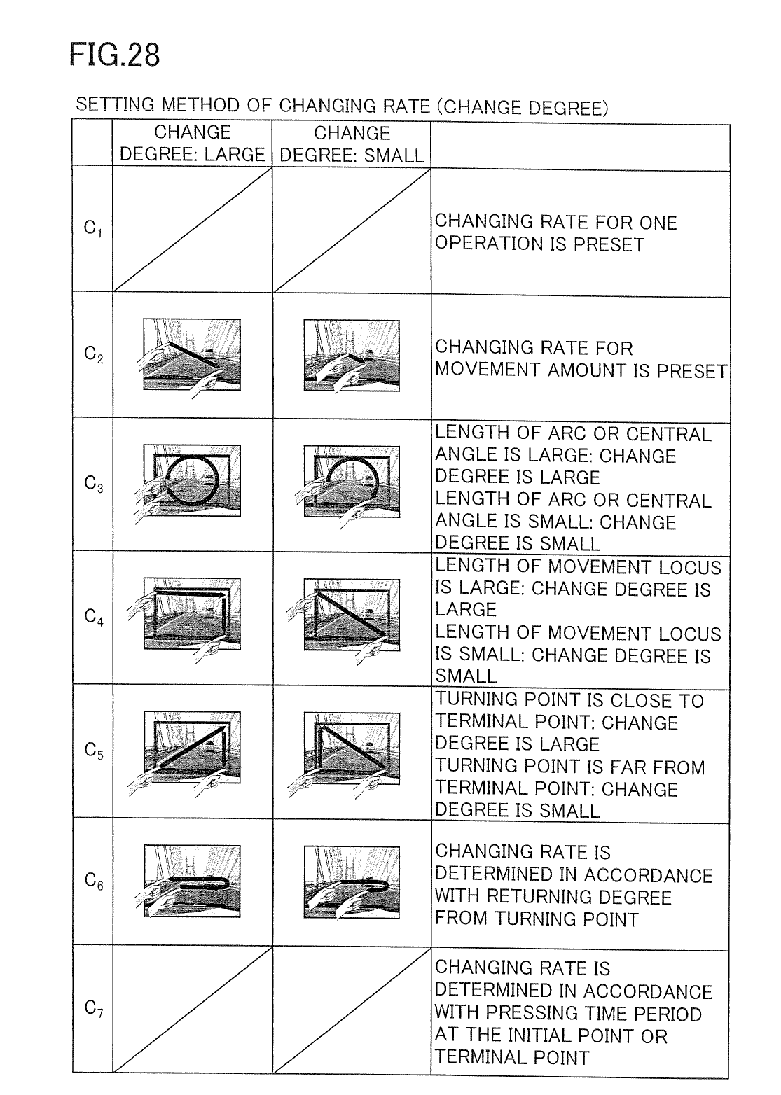

In a method B₂, a change direction of a size of the clipping frame is determined by a movement direction from an initial point to a terminal point in a movement locus of a touch position (it can be said that a change direction of a size of the clipping frame is determined on the basis of a positional relationship between the initial point and the terminal point). In a section corresponding to the method B₂ in FIG. 25, a manner in which one finger moves on the display screen 51 along an arrow in the diagram is illustrated. The same is true for sections corresponding to the methods B₃ to B₅ in FIG. 25 and sections corresponding to the methods C₂ to C₆ in FIG. 28 that will be described later. The movement locus of the touch position means a locus of a contact position between the finger and the display screen 51 (i.e., the touch position), which is the same as the “movement locus of the finger” described above in the first embodiment. Hereinafter, if referred to initial point and terminal point simply, they mean the initial point and the terminal point on the movement locus of the touch position. The method B₂ can be performed in combination with the method A₄ or A₅. For instance, in the display screen 51, if a movement direction of the touch position is the right direction so that the terminal point is located on the right side of the initial point, the clipping frame should be set in accordance with the method A₄ or A₅. By this setting, a size of the clipping frame is decreased. On the contrary, if a movement direction of the touch position is the left direction so that the terminal point is located on the left side of the initial point, a size of the clipping frame should be increased (see FIG. 6A as for definition of up, down, left and right). Alternatively, for example, on the display screen 51, if a movement direction of the touch position is the down direction so that the terminal point is located on the lower side of the initial point, the clipping frame should be set in accordance with the method A₄ or A₅. By this setting, a size of the clipping frame is decreased. On the contrary, if a movement direction of the touch position is the up direction so that the terminal point is located on the upper side of the initial point, a size of the clipping frame should be increased. It is possible to set the relationship between the movement direction and the change direction of a size of the clipping frame in the opposite manner.

[Method B₃]

In a method B₃, a change direction of a size of the clipping frame is determined on the basis of a positional relationship between the initial point and the terminal point on the movement locus of the touch position. The method B₃ can also be performed in combination with the method A₄ or A₅. For instance, if the terminal point is closer to the center of the display screen 51 than the initial point, the clipping frame should be set in accordance with the method A₄ or A₅. By this setting, a size of the clipping frame can be decreased. On the contrary, if the initial point is closer to the center of the display screen 51 than the terminal point, a size of the clipping frame should be increased. It is possible to set the relationship between the positional relationship and a change direction of a size of the clipping frame in the opposite manner.

[Method B₄]

In a method B₄, a change direction of a size of the clipping frame is determined on the basis of whether or not a movement direction of the touch position is reversed while the touch position is moved. The method B₄ can also be performed in combination with the method A₄ or A₅. For instance, in the process of moving from the initial point to the terminal point, if the touch position moves only in the same direction, a movement direction of the touch position is not reversed: In this case, the clipping frame should be set in accordance with the method A₄ or A₅. By this setting, a size of the clipping frame is decreased. On the contrary, if the touch position moves from the initial point to a certain direction and then moves in the opposite direction to reach the terminal point, it is decided that a movement direction of the touch position is reversed. In this case, a size of the clipping frame should be increased. Further, even if there is a reverse, if a movement of the touch position after the reverse is small, a change direction of a size of the clipping frame may be set to the decrease direction. It is possible to set the relationship between presence or absence of the reverse and a change direction of a size of the clipping frame in the opposite manner.

[Method B₅]

When a method B₅ is used, it is supposed that when the touch position moves from the initial point to the terminal point, the touch position moves in the clockwise direction or in the counterclockwise direction. On the display screen 51, the direction in which the touch position moves from the left side region via the upper side region to the right side region corresponds to the clockwise direction (see FIG. 6A). The method B₅ can be performed in combination with any one of the method A₃ to A₅. For instance, in the process that the touch position moves from the initial point to the terminal point, if the touch position moves in the clockwise direction, the clipping frame should be set in accordance with any one of the method A₃ to A₅. By this setting, a size of the clipping frame is decreased. On the contrary, in the process that the touch position moves from the initial point to the terminal point, if the touch position moves in the counterclockwise direction, a size of the clipping frame should be increased. It is possible to set the relationship between the movement direction of the touch position and a change direction of a size of the clipping frame in the opposite manner.

[Method B₆]

When a method B₆ is used, it is supposed that the finger is still at the initial point or the terminal point for a certain time period. One of a time period while the finger is still at the initial point keeping a contact state with the display screen 51 and a time period while the finger is still at the terminal point keeping a contact state with the display screen 51 can be adopted as a target still period. In the method B₆, a change direction of a size of the clipping frame is determined in accordance with a time length of the target still period. The method B₆ can be performed in combination with any one of the methods A₁ to A₅. Since a movement of the touch position is not expected in the methods A₁ and A₂, if the method A₁ or A₂ is used, the touch position itself in the method A₁ or A₂ should be regarded as the initial point or the terminal point. For instance, a counter (not shown) which outputs a reset signal every time when a constant unit time passes is used, and a change direction of a size of the clipping frame is set to the decrease direction if the number of the reset signals output during the target still period is an odd number, while the change direction is set to the increase direction if the number is an even number. The relationship between the number and the change direction may be set in the opposite manner.

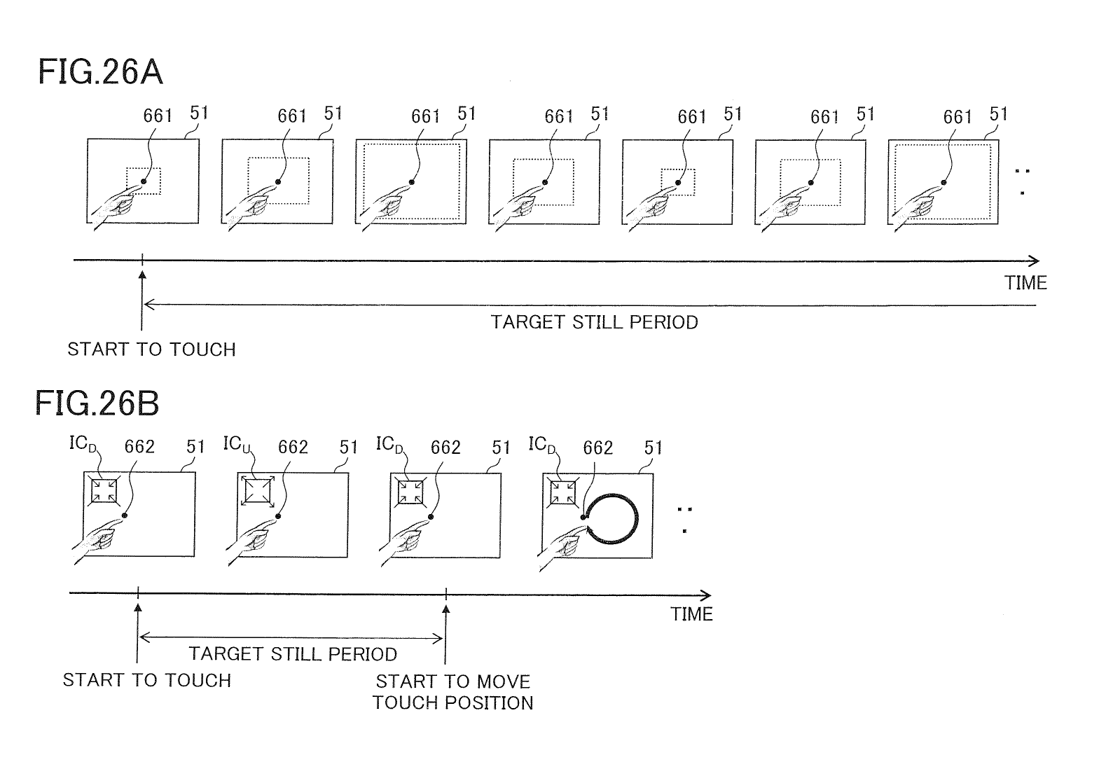

A specific example will be described. For instance, in the case where the method B₆ is combined with the method A₁, as illustrated in FIG. 26A, when a finger touches a certain position 661 on the display screen 51, a size of the clipping frame on the display screen 51 first increases gradually with the position 661 at the center as time passes. When a constant time passes, a change direction of a size of the clipping frame is reversed so that a size of the clipping frame on the display screen 51 decreases gradually this time as time passes. A broken line frame illustrated in FIG. 26A is the clipping frame on the display screen 51. When a size of the clipping frame on the display screen 51 is decreased to a certain extent, a change direction of a size of the clipping frame is reversed to the increase direction again, so that the operation similar to that described above is repeated. Then, a size of the clipping frame is determined at a time point when the finger is released from the display screen 51 (at a time point when the target still period is finished). Specifically, the clipping frame on the display screen 51 at the time point when the target still period is finished is set on the original input image 600 or the input image 620, so that the image in the set clipping frame is extracted as the clipped image from the original input image 600 or the input image 620.

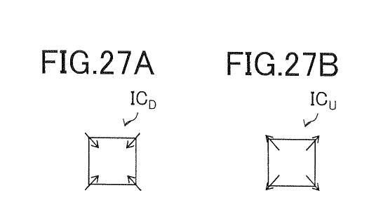

In a combination example of the methods B₆ and A₁ corresponding to FIG. 26A, an icon IC_{D} as illustrated in FIG. 27A may be displayed for indicating a decrease of a size of the clipping frame during the period while a size of the clipping frame on the display screen 51 is decreasing, and an icon IC_{U} as illustrated in FIG. 27B may be displayed for indicating an increase of a size of the clipping frame during the period while a size of the clipping frame on the display screen 51 is increasing.

In addition, with reference to FIG. 26B, an operational example in the case where the method B₆ is combined with the method A₃ will be described. In this operational example, the period while the finger is still at the initial point is regarded as the target still period. As illustrated in FIG. 26B, when the finger and the display screen 51 start to contact with each other at a position 662 on the display screen 51, the target still period starts and a view angle decrease setting period starts. In the target still period, the view angle decrease setting period and a view angle increase setting period appear alternately every time when a unit time passes. It is preferable to display the icon IC_{D} in the view angle decrease setting period, and it is preferable to display the icon IC_{U} in the view angle increase setting period. When the finger starts to move from the position 662 during the view angle decrease setting period, a change direction of a size of the clipping frame is determined to be the decrease direction. When the finger starts to move from the position 662 during the view angle increase setting period, a change direction of a size of the clipping frame is determined to be the increase direction. FIG. 26B corresponds to a state where the change direction is determined to be the decrease direction. During the period while the finger is moved, the icon IC_{D} is displayed.

—Setting Method of Changing Rate (Increase Rate and Decrease Rate)—

Next, a setting method of a changing rate in a size of the clipping frame will be described. A size of the clipping frame before a size of the clipping frame is changed is represented by SIZE_{BF}, and a size of the clipping frame after the size of the clipping frame is changed is represented by SIZE_{AF}. Then, the changing rate is expresssed by “SIZE_{AF}/SIZE_{BF}”. The size of the clipping frame is expressed by, for example; the number of pixels in the clipping frame. A degree of change in the size of the clipping frame is referred to as a “change degree”. If the change direction of a size of the clipping frame is the decrease direction, the changing rate is the decrease rate having a value smaller than one. In this case, if the changing rate (SIZE_{AF}/SIZE_{BF}) is closer to zero, the change degree (change degree of decrease) is larger. If the changing rate (SIZE_{AF}/SIZE_{BF}) is closer to one, the change degree (change degree of decrease) is smaller. If the change direction of a size of the clipping frame is the increase direction, the changing rate is the increase rate having a value larger than one. In this case, if the changing rate (SIZE_{AF}/SIZE_{BF}) is larger, the change degree (change degree of increase) is larger. If the changing rate (SIZE_{AF}/SIZE_{BF}) is closer to one, the change degree (change degree of increase) is smaller.

As a setting method of the changing rate, methods C₁ to C₇ will be described below. FIG. 28 illustrates an outline of the methods C₁ to C₇. Any one of the methods B₁ to B₆ described above can be performed in combination with any one of the methods C₁ to C₇ as long as no contradiction arises. It is possible to set the relationship of large and small of the change degree exemplified in the description of the method Cᵢ in the opposite manner.

[Method C₁]

In the method C₁, a changing rate for one operation is set fixedly in advance. Specifically, if a change direction of a size of the clipping frame is determined to be the decrease direction by the method Bᵢ described above, a size of the clipping frame is decreased at a decrease rate determined in advance regardless of a moving state or the like of the finger. On the contrary, if the change direction is determined to be the increase direction, a size of the clipping frame is increased at an increase rate determined in advance regardless of a moving state or the like of the finger. The method C₁ can be performed in combination with any one of the methods A₁ to A₅.

[Method C₂]

In a method C₂, a changing rate is set in accordance with the movement amount of the finger on the display screen 51, and the changing rate for the movement amount is fixedly set in advance. Therefore, if the movement amount is determined, the changing rate is automatically determined.

[Method C₃]

A method C₃ is used in combination with the method A₃. In the method A₃, the movement locus of the touch position draws an arc. In the method C₃, if a length of the arc is larger, the change degree of decrease or increase is set to a larger value. If the length of the arc is smaller, the change degree of decrease or increase is set to a smaller value. Alternatively, if a central angle of the arc is larger, the change degree of decrease or increase is set to be larger. If the central angle of the arc is smaller, the change degree of decrease or increase is set to be smaller. When the method C₃ is used, the touch position may be moved along a circumference on the display screen 51 a plurality of turns. When the touch position is moved along a circumference on the display screen 51 just one turn, a length of the arc agrees with a length of the circumference and the central angle of the arc is decided to be 360 degrees. When the touch position is moved along a circumference on the display screen 51 just two turns, a length of the arc agrees with twice a length of the circumference and the central angle of the arc is decided to be 720 degrees.

[Method C₄]

A method C₄ is used in combination with the method A₄ or A₅. In the method C₄, a length of the movement locus of the touch position by the method A₄ or A₅ is determined. If the determined length is larger, the change degree of decrease or increase is set to be larger. If the determined length is smaller, the change degree of decrease or increase is set to be smaller.

[Method C₅]

When a method C₅ is used, there is a turning point between the initial point and the terminal point on the movement locus of the touch position. Specifically, in the method C₅, it is assumed that the touch position moves in a certain direction from the initial point to the turning point and then the touch position moves in another direction from the turning point to the terminal point. Then, a distance between the turning point and the terminal point is determined. If the determined distance is shorter, the change degree of decrease or increase is set to be larger. If the determined distance is longer, the change degree of decrease or increase is set to be smaller. The method C₅ can be used in combination with the method A₄ or A₅. In this combination, contents of the method A₄ or A₅ may be corrected a little. For instance, if the method C₅ is combined with the method A₄, a rectangular frame that is as small as possible to include the initial point, the turning point and the terminal point should be regarded as the clipping frame.

[Method C₆]

When a method C₆ is used, it is assumed that a turning point exists between the initial point and the terminal point on the movement locus of the touch position, and the direction of moving from the initial point to the turning point is opposite to the direction of moving from the turning point to the terminal point (here, the terminal point may be substantially the same as the turning point). The touch position moves from the initial point to the turning point, and after that, the touch position goes back to the initial point side. In accordance with this going back degree, the changing rate is determined. Specifically, for example, a distance d_{SM} between the initial point and the turning point, and a distance d_{ME} between the turning point and the terminal point are determined. If a distance ratio (d_{ME}/d_{SM}) is larger, the change degree of decrease or increase is set to be larger. If the distance ratio (d_{ME}/d_{SM}) is smaller, the change degree of decrease or increase is set to be smaller. The method C₅ can be used in combination with the method A₄ or A₅. In this combination, the turning point may be regarded as the terminal point in the method A₄ or A₅.

[Method C₇]

In method C₇, it is assumed that the finger is still at the initial point or the terminal point for a certain period of time. One of a time period while the finger is still at the initial point keeping a contact state with the display screen 51 and a time period while the finger is still at the terminal point keeping a contact state with the display screen 51 can be adopted as a target still period. In the method C₇, the changing rate is determined in accordance with a time length of the target still period. Specifically, for example, if the time length of the target still period is longer, the change degree of decrease or increase is set to be larger. If the time length of the target still period is shorter, the change degree of decrease or increase is set to be smaller. The method C₇ can be performed in combination with any one of the methods A₁ to A₅. Since a movement of the touch position is not expected in the methods A₁ and A₂, when the methods A₁ and A₂ are used, the touch position itself in the method A₁ or A₂ should be regarded as the initial point or the terminal point.

—Notification of Information about Increase or Decrease of a Size of the Clipping Frame—

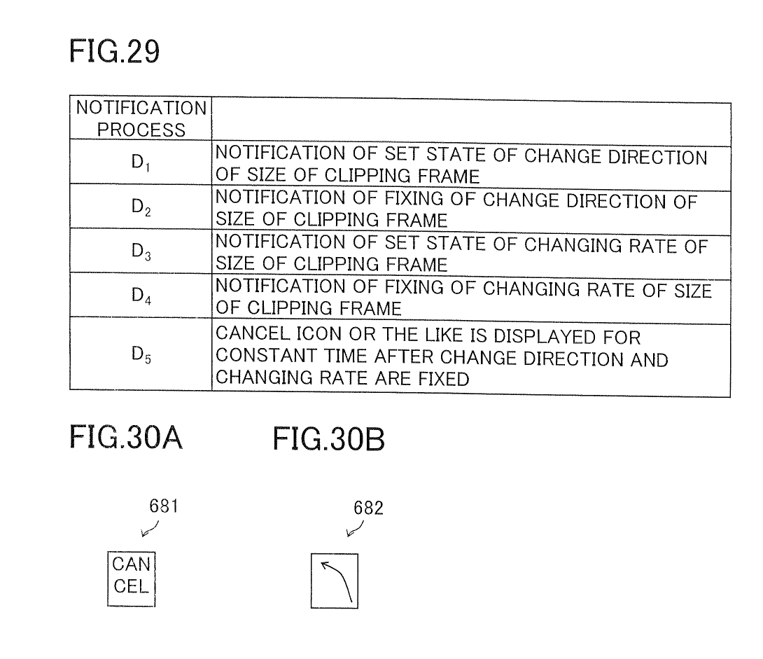

Next, A method of notifying the user of information about increase or decrease of a size of the clipping frame or the like will be described. As a process concerning this notification, notification processes D₁ to D₅ will be described below. FIG. 29 illustrates an outline of the notification processes D₁ to D₅. A notification process Dᵢ can be combined with any one of the methods A₁ to A₅ illustrated in FIG. 21, and can be combined with any one of the methods B₁ to B₆ illustrated in FIG. 25, and can be combined with any one of the methods C₁ to C₇ illustrated in FIG. 28. Further, a plurality of notification processes among the notification processes D₁ to D₅ can be freely combined with each other and performed.

[Notification Process D₁]

The notification process D₁ will be described. In the notification process D₁, before the change direction of a size of the clipping frame is fixed, and during the period while the touch panel operation is being performed for setting the change direction of a size of the clipping frame, the icon IC_{D} illustrated in FIG. 27A or the icon IC_{U} illustrated in FIG. 27B is displayed. The process for displaying the icon IC_{D} or IC_{U} during the target still period as described above with reference to FIG. 26B is one type of the notification process D₁. The icon IC_{D} is displayed if it is estimated that the change direction becomes the decrease direction according to the current touch panel operation though the change direction of a size of the clipping frame is not fixed. On the contrary, if it is estimated that the change direction becomes the increase direction according to the current touch panel operation, the icon IC_{U} is displayed. The display controller 20 in FIG. 2 can perform this estimation on the basis of the touch operation information (see FIG. 5).

For instance, in the case where the method B₅ illustrated in FIG. 25 is used, when the touch position starts to draw an arc from the initial point in a clockwise direction, it is estimated that a change direction of a size of the clipping frame will be determined to be the decrease direction with high probability. When a central angle of the arc drawn by the touch position exceeds 180 degrees, a change direction of a size of the clipping frame is fixed to be the decrease direction. On the contrary, if the touch position starts to draw an arc from the initial point in a counterclockwise direction, it is estimated that a change direction of a size of the clipping frame will be determined to be the increase direction with high probability. When a central angle of the arc drawn by the touch position exceeds 180 degrees, a change direction of a size of the clipping frame is fixed to be the increase direction.

[Notification Process D₂]

When a change direction of a size of the clipping frame is fixed, it is possible to inform the user about that a change direction is fixed. In this case, the notification process for informing about that a change direction is fixed is included in the notification process D₂. Any method can be adopted for the notification performed by the notification process D₂. For instance, if it is fixed that a change direction of a size of the clipping frame becomes the decrease direction, the icon IC_{D} on the display screen 51 may be blinked so as to notifying that a change direction is fixed. Alternatively, any method working on human five senses (sight, hearing and the like) may be used for notifying that a change direction is fixed. The same is true in the case where the change direction is fixed to be the increase direction. The notification in the notification process D₁ (e.g., a display of the icon IC_{D} or IC_{U}) and the notification in the notification process D₂ (e.g., a blink display of the icon IC_{D} or IC_{U}) corresponds to the notification for informing the user about which of the increasing operation and the decreasing operation the touch panel operation performed to the camera monitor 17 corresponds to. By this notification, the user can perform a desired operation easily.

[Notification Process D₃]

A notification process D₃ will be described. In the notification process D₃, an index indicating a current changing rate is displayed before a changing rate of a size of the clipping frame is fixed and during the period while the touch panel operation for determining a changing rate of a size of the clipping frame is performed. Any method of indicating a changing rate may be adopted. For instance, it is possible to notify the user about a current changing rate by using an icon having a bar shape, a numerical value, a color or the like.

For instance, in the case where the method B₅ illustrated in FIG. 25 and the method C₃ illustrated in FIG. 28 is used, it is supposed that a change direction of a size of the clipping frame is fixed to be the decrease direction when the touch position moves in a clockwise direction. In this case, a changing rate of the decrease is not fixed until the position of the terminal point is fixed. However, if the touch position in each time point is supposed to be the position of the terminal point, the changing rate corresponding to each time point can be calculated. The process of notifying the changing rate corresponding to each time point before the position of the terminal point is fixed corresponds to the notification process D₃. When the finger is actually released from the display screen 51 so that the position of the terminal point is fixed, the changing rate of the decrease is fixed.

[Notification Process D₄]

When a changing rate of a size of the clipping frame is fixed, it is possible to notify the user about that a changing rate is fixed. In this case, the notification process of notifying that a changing rate is fixed is included in the notification process D₄. It is possible to notify that a changing rate is fixed by a display of a particular icon, or by any other method working on human five senses (sight, hearing and the like). In addition, the fixed changing rate itself is notified to the user by the notification process D₄. Any method of indicating the fixed changing rate may be adopted. For instance, it is possible to notify the user about the fixed changing rate by using an icon having a bar shape, a numerical value, a color or the like.

[Notification Process D₅]

It is possible to display a cancel icon or a cancel gesture icon for demonstrating a canceling gesture for a cancel acceptance period having a constant time length (e.g., a few seconds) after a change direction of a size of the clipping frame and a changing rate are fixed. The display of the cancel icon and the cancel gesture icon is included in the notification process D₅. The icons 681 and 682 illustrated in FIGS. 30A and 30B are examples of the cancel icon and the cancel gesture icon, respectively. When the user performs a touch panel operation of pressing the cancel icon 681 or a touch panel operation indicated by the cancel gesture icon 682 during the cancel acceptance period after a size of the clipping frame is changed, a change of a size of the clipping frame is cancelled, so that a size of the clipping frame is reset to that before the change. It is possible to display a remaining time until the cancel acceptance period is finished, during the cancel acceptance period.

For instance, it is supposed that execution of the process of decreasing a size of the clipping frame is fixed by a certain touch panel operation in the state where the display image of the camera monitor 17 is the input image 620 (see FIGS. 22A and 23), and after that, the process of decreasing a size of the clipping frame is actually performed so that the display image of the camera monitor 17 is changed to the clipped image 630. In this case, the cancel icon 681 or the cancel gesture icon 682 is displayed together with the clipped image 630 for a time length of the cancel acceptance period after the time point when the display image of the camera monitor 17 is changed from the input image 620 to the clipped image 630. If the touch panel operation of pressing the cancel icon 681 with a finger during the period while the cancel icon 681 is displayed, or if the touch panel operation indicated by the cancel gesture icon 682 is performed during the period while the cancel gesture icon 682 is displayed, the display image is reset to the state before the clipping frame is changed. Specifically, the display image of the camera monitor 17 is reset to the input image 620 from the clipped image 630.

### Specific Operational Example

Next, specific operational examples of the digital camera 1 in which each method and each process described above are used will be described.

### First Operational Example

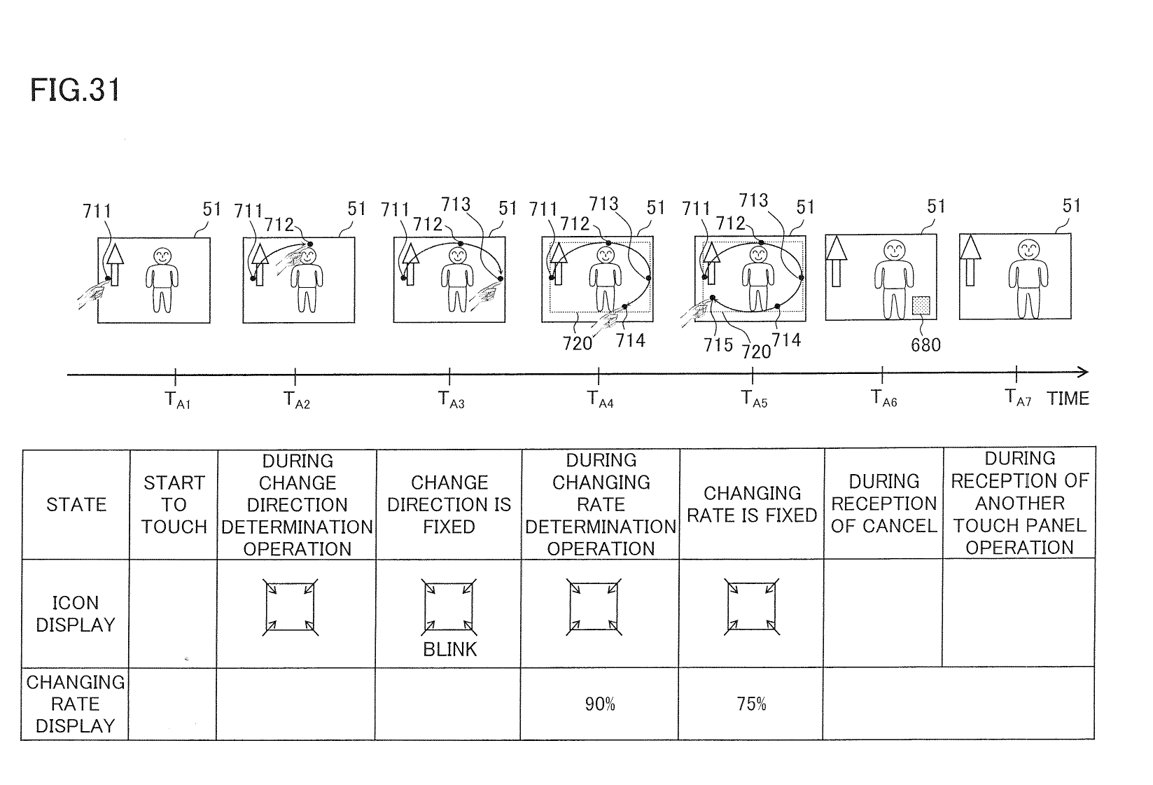

A first operational example will be described with reference to FIG. 31. FIG. 31 is a diagram illustrating a manner of the display screen 51 and the like in the first operational example. In the first operational example, the methods A₃, B₅ and C₃ are combined and used (see FIGS. 21, 25 and 28), and the notification processes D₁ to D₅ are performed. In addition, in the first operational example, any method described above in the fourth embodiment can be used. Other than that, in the first operational example, any method described above in the fifth embodiment (particularly, for example, the third display control method) and any method described above in the sixth embodiment (particularly, for example, the sixth display control method) can be used.

It is supposed that the time T_{A(i+1)} is after the time t_{Ai}. The positions 711 to 715 are touch positions at the time T_{A1} to T_{A5}, respectively. The positions 711 to 715 are positions that are different from each other, and the locus formed by connecting the positions 711 to 715 in order draws an arc. The positions 711 and 715 are respectively a position of the initial point and a position of the terminal point of the locus. It supposed that the touch position moves in a clockwise direction in the process that the touch position moves from the position 711 to the position 715. For instance, the input image 620 is displayed on the display screen 51 from the time T_{A1} to the time T_{A5}, and the clipped image 630 is displayed on the display screen 51 at the time T_{A6} and the time T_{A7} (see FIG. 23).

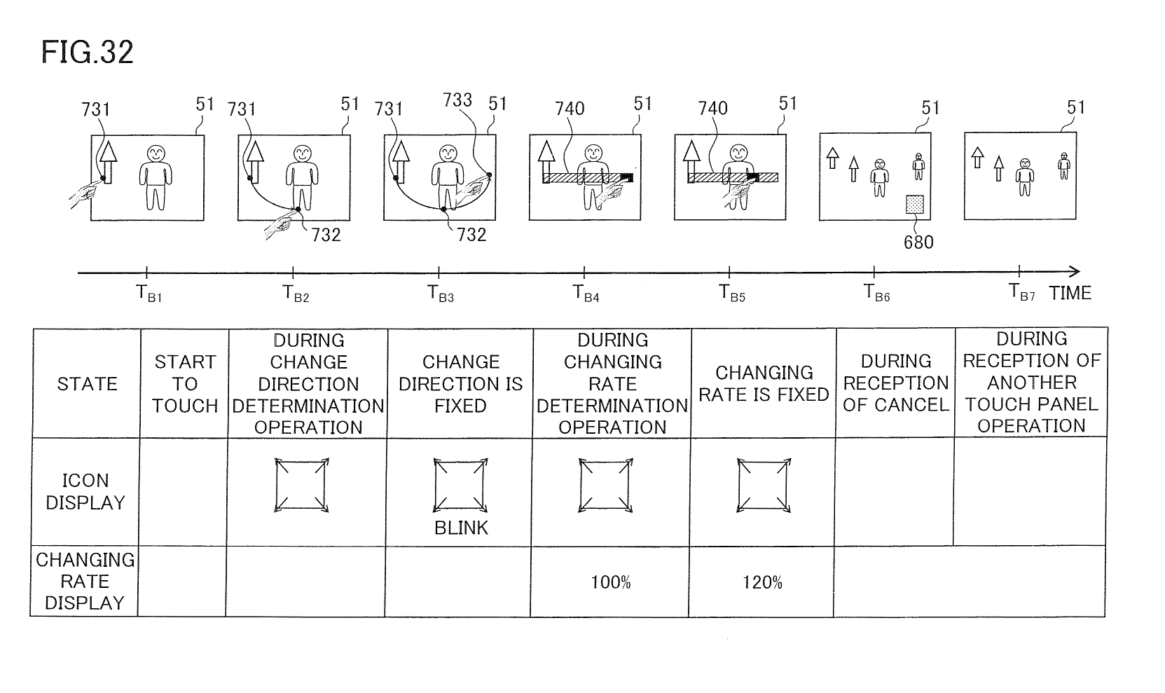

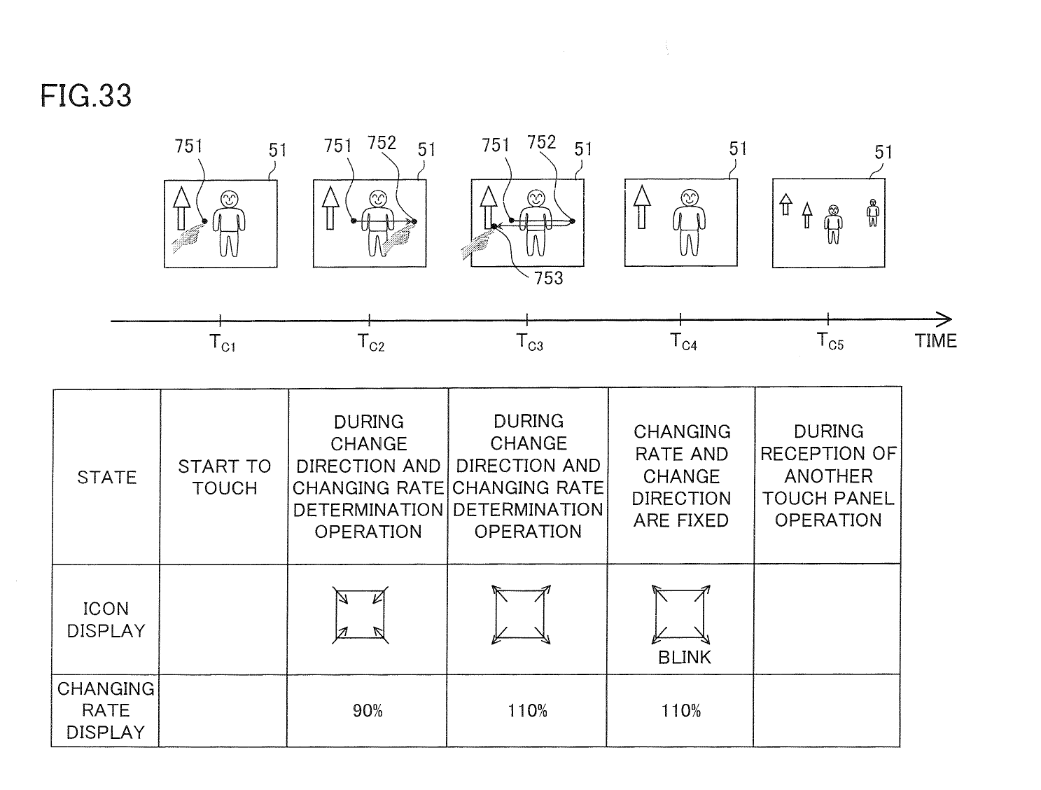

Specific description will be added along time sequence. A finger touches a position 711 on the display screen 51 at time T_{A1}, and the touch position moves from the position 711 to the position 712 during the period from time T_{A1} to time T_{A2}. In this case, the display controller 20 performs the notification process D₁. Specifically, it estimates that a change direction of a size of the clipping frame will be determined to be the decrease direction with high probability from the movement locus between positions 711 and 712 on the basis of the method B₅ illustrated in FIG. 25, and the icon IC_{D} is displayed at time T_{A2} (see also FIG. 27A). The icon IC_{D} can be displayed on the display screen 51, but the icon IC_{D} is illustrated separately from the illustration of the display screen 51 in FIG. 31 in order to avoid complicated illustration (the same is true in FIGS. 32 and 33 that will be referred to later).

Next, the touch position moves from the position 712 to the position 713 in the period from time T_{A2} to time T_{A3}. In this case, the display controller 20 performs the notification process D₂. Specifically, the central angle of the arc formed by the movement locus between the position 711 and the position 713 exceeds 180 degrees at time T_{A3}. Therefore, a change direction of a size of the clipping frame is fixed to be the decrease direction, and in order to notify the user about that a change direction of a size of the clipping frame is fixed, the icon IC_{D} is blinked at time T_{A3}. This blink display is continued for a constant period of time.

Next, the touch position moves from the position 713 to the position 714 during the period from time T_{A3} to time T_{A4}. In this case, the display controller 20 performs the notification process D₃. Specifically, at time T_{A4}, the changing rate described above is calculated on the basis of the assumption that the position 714 is the terminal point, and the calculated changing rate (90% in the example illustrated in FIG. 31) is displayed. After that, the touch position moves from the position 714 to the position 715 during the period from time T_{A4} to time T_{A5}. When the finger is released from the display screen 51 at time T_{A5}, the position of the terminal point is fixed to be the position 715. At time T_{A5}, a changing rate corresponding to the terminal point position 715 is calculated, and the calculated changing rate (75% in the example illustrated in FIG. 31) is displayed. In addition, when the display controller 20 performs the notification process D₄, the user is notified at time T_{A5} about that the changing rate is fixed. Further, at time T_{A4} and time T_{A5}, the clipping frame 720 based on the movement locus of the touch position is displayed. In addition, the display of the icon IC_{D} is continued after the change direction is fixed until at least a changing rate is fixed at time T_{A5}.

The cancel acceptance period starts from time T_{A5} and the cancel acceptance period ends right before time T_{A7}. The time T_{A6} is time in the cancel acceptance period. Therefore, at time T_{A6}, the icon 680 that is the cancel icon 681 or the cancel gesture icon 682 is displayed. When the cancel acceptance period is finished, the display of the icon 680 is deleted so as to reach a state of receiving other touch panel operation. Note that the changing rate displayed at time T_{A4} or the like may be a changing rate based on a size of the original input image 600 or may be a changing rate based on a size of the input image 620. In addition, as described above, the touch position may be moved a plurality of turns along the circumference on the display screen 51 for determining the changing rate.

### Second Operational Example

With reference to FIG. 32, a second operational example will be described. FIG. 32 is a diagram illustrating a manner of the display screen 51 and the like in the second operational example. In the second operational example, the methods A₅, B₅ and C₆ are combined and used (see FIGS. 21, 25 and 28), and the notification processes D₁ to D₅ are performed. In addition, in the second operational example, any method described above in the fourth embodiment can be used. Other than that, in the second operational example, any method described above in the fifth embodiment and any method described above in the sixth embodiment (particularly, for example, the sixth display control method) can be used.

It is supposed that time T_{B(i+1}) is after time t_{Bi}. Positions 731 to 733 are touch positions at time T_{B1} to time T_{B3}, respectively. The positions 731 to 733 are positions different from each other, and a locus formed by connecting the positions 731 to 733 in order draws an arc. In the process that the touch position moves from the position 731 to the position 733, it is supposed that the touch position moves in a counterclockwise direction. For instance, in the period from time T_{B1} to time T_{B5}, the input image 620 is displayed on the display screen 51, and the original input image 600 is displayed on the display screen 51 at time T_{B6} and time T_{B7} (see FIG. 22A).

Specific description will be added along time sequence. A finger touches a position 731 on the display screen 51 at time T_{B1}, and the touch position moves from the position 731 to the position 732 during the period from time T_{B1} to time T_{B2}. In this case, the display controller 20 performs the notification process D₁. Specifically, it estimates that a change direction of a size of the clipping frame will be determined to be the increase direction with high probability from the movement locus between positions 731 and 732 on the basis of the method B₅ illustrated in FIG. 25, as a result, the icon IC_{U} is displayed at time T_{B2} (see also FIG. 27B).

Next, the touch position moves from the position 732 to the position 733 during the period from time T_{B2} to time T_{B3}. In this case, the display controller 20 performs the notification process D₂. Specifically, at time T_{B3}, a central angle of the arc formed by the movement locus between the positions 731 and 733 exceeds 180 degrees. Therefore, a change direction of a size of the clipping frame is fixed to be the increase direction, and in order to notify the user about that a change direction of a size of the clipping frame is fixed, the icon IC_{U} is blinked at time T_{B3}. This blinking display is continued for a constant period of time.

In the second operational example, since the method C₆ (see FIG. 28) is used as a setting method of a changing rate, a bar icon 740 is displayed for supporting the setting operation of a changing rate performed by the user. The bar icon 740 is an icon having a bar shape extending from the position 733 to the position 731 and is display until the changing rate is fixed. In this example, the bar icon 740 is displayed at least at time T_{B4} and time T_{B5}. At time T_{B4}, the display controller 20 performs the notification process D₃. Here, it is supposed that a touch position at time T_{B4} is the same as the position 733. Then, when the notification process D₃ is performed, the changing rate is calculated on the assumption that the position 733 is the terminal point, and the calculated changing rate (100% in the example illustrated in FIG. 32) is displayed. After that, the touch position is moved from the position 733 to the left side of the position 733 during the period from T_{B4} to time T_{B5}. When the finger is released from the display screen 51 at time T_{B5}, the position of the terminal point is fixed. At time T_{B5}, a changing rate corresponding to the fixed terminal point position is calculated, and the calculated changing rate (120% in the example illustrated in FIG. 32) is displayed. In addition, at time T_{B5}, the user may be notified by sound output or the like about that a changing rate is fixed. In addition, after the change direction is fixed, the display of the icon IC_{U} is continued at least until time T_{B5} when the changing rate is fixed.

The cancel acceptance period starts from time T_{B5}, and the cancel acceptance period ends right before the time T_{B7}. The time T_{B6} is time in the cancel acceptance period. Therefore, at time T_{B6}, the icon 680 that is the cancel icon 681 or the cancel gesture icon 682 is displayed. When the cancel acceptance period is finished, the display of the icon 680 is deleted so as to reach a state where other touch panel operation can be accepted.

### Third Operational Example

With reference to FIG. 33, a third operational example will be described. FIG. 33 is a diagram illustrating a manner of the display screen 51 and the like in the third operational example. In the third operational example, the methods A₅, B₄ and C₁ are combined and used (see FIGS. 21, 25 and 28), and the notification processes D₁ to D₄ are performed. In addition, in the first operational example, any method described above in the fourth embodiment can be used. Other than that, in the third operational example, any method described above in the fifth embodiment (particularly, for example, the third display control method) and any method described above in the sixth embodiment (particularly, for example, the sixth display control method) can be used.

It is supposed that time T_{C(i+1)} is after time t_{Ci}. Positions 751 to 753 are touch positions at time T_{C1} to T_{C3}, respectively. It is supposed that the direction from the position 751 to the position 752 is the right direction, while the direction from the position 752 to the position 753 is the left direction. For instance, the input image 620 is displayed on the display screen 51 in the period from time T_{C1} to T_{C4}, and the original input image 600 is displayed on the display screen 51 at time T_{C5} (see FIG. 22A).

Specific description will be added along time sequence. A finger touches a position 751 on the display screen 51 at time T_{C1}, and the touch position moves from the position 751 to the position 752 during the period from time T_{C1} to time T_{C2}. In this case, the display controller 20 performs the notification process D₁. In the process that the touch position moves from the position 751 to the position 752, there is no reverse in the movement direction of the touch position. Therefore, at time T_{C2}, it is estimated that a change direction of a size of the clipping frame is determined to be the decrease direction with high probability on the basis of the method B₄ illustrated in FIG. 25. Therefore, the icon IC_{D} is displayed at time T_{C2} (see also FIG. 27A). Further, in the third operational example, the method C₁ illustrated in FIG. 28 is adopted. Therefore, the notification process D₃ can be performed at time T_{C2}, and a changing rate as a result (90% in the example illustrated in FIG. 33) is displayed.

The movement direction of the touch position is reversed with respect to time T_{C2} as a center, and the touch position moves from the position 752 to the position 753 during the period from time T_{C2} to time T_{C3}. The display controller 20 detects the reverse so as to estimate that a change direction of a size of the clipping frame is determined to be the increase direction, and the icon IC_{U} is displayed at time T_{C3} (see FIG. 27B). Further, the notification process D₃ is performed at time T_{C3}, and a changing rate as a result (110% in the example illustrated in FIG. 33) is displayed.

When the finger is released from the display screen 51 at time T_{C4}, the above-mentioned change direction and changing rate are fixed. Then, the display controller 20 performs the notification processes D₂ and D₄. Specifically, the icon IC_{U} is blinked at time T_{C4} so as to notify the user about that a change direction is fixed to be the increase direction. This blink display is continued for a constant period of time. Further, the fixed changing rate (110% in the example illustrated in FIG. 33) is also displayed at time T_{C4}. In addition, it is possible to notify the user by sound output or the like about that a changing rate is fixed. Note that in this example, it is considered that a change direction and a changing rate are fixed at time T_{C4}, but it is possible to fix them at a time point when a reverse of the movement direction of the touch position is detected.

According to this embodiment, not only a decrease of the angle of view of the display image but also an increase of the angle of view of the display image can be instructed by an intuitive touch panel operation.

### Tenth Embodiment

A tenth embodiment of the present invention will be described. The tenth embodiment is an embodiment based on the description in the seventh embodiment, and as to matters that are not particularly described in this embodiment, the description in the seventh embodiment is also applied to this embodiment as long as no contradiction arises. Therefore, the following description in the tenth embodiment is an operational description of the digital camera 1 in the imaging mode. The matters described in the ninth embodiment can be applied to the seventh embodiment. The tenth embodiment corresponds to a combination of the seventh and the ninth embodiments.

An operation in which a still image is taken in the imaging mode will be described. When a still image is taken in the imaging mode, one frame image indicating the still image is displayed on the camera monitor 17 and is supplied to the clip processing unit 62 illustrated in FIG. 9 as an input image. In the state where the entire image of the input image is displayed on the camera monitor 17, the photographer can perform the touch panel operation by the method A. When the touch panel operation is performed by the method Aᵢ, the clip setting unit 61 generates the clipping information on the basis of the touch operation information based on the touch panel operation, and the clip processing unit 62 generates the clipped image from the still image as the input image in accordance with the clipping information. Here, the input image and the clipped image can be regarded as the original input image 600 and the clipped image 610, respectively (see FIG. 22A).

An operation in which a moving image is taken in the imaging mode will be described. When a moving image is taken in the imaging mode, frame images forming the moving image are sequentially displayed on the camera monitor 17 and are supplied to the clip processing unit 62 illustrated in FIG. 9 as input frame images. In the state where the entire image of a certain input frame image is displayed on the camera monitor 17, the photographer can perform the touch panel operation according to the method Aᵢ. When the touch panel operation according to the method Aᵢ is performed, the clip setting unit 61 generates the clipping information on the basis of the touch operation information based on the touch panel operation, and the clip processing unit 62 generates the clipped image from each input frame image in accordance with the clipping information. Here, each input frame image can be regarded as the original input image 600, and the clipped image corresponding to each input frame image can be regarded as the clipped image 610 (see FIG. 22A).

Now, as described above in the ninth embodiment, the clipped image 610 is regarded as a new input image 620, and the state where the input image 620 is displayed is regarded as a reference state (see FIG. 22A). This reference state corresponds to the state where the clipping frame 601 is set on the original input image 600. In this reference state, similarly to the ninth embodiment, the user can perform the increasing operation for changing the clipping frame set on the original input image 600 from the clipping frame 601 to the clipping frame 601A and the decrease operation for changing the clipping frame set on the original input image 600 from the clipping frame 601 to the clipping frame 601B by using the touch panel (see FIGS. 24A and 24B). The operational example of increasing or decreasing a size of the clipping frame is as described above in the ninth embodiment.

If the increasing operation is performed, the image inside the clipping frame 601A can be displayed as the clipped image, and the image data inside the clipping frame 601A can be recorded in the recording medium 15 as the image data of the clipped image. If the decreasing operation is performed, the image inside the clipping frame 601B can be displayed as the clipped image, and the image data inside the clipping frame 601B can be recorded in the recording medium 15 as the image data of the clipped image.

As described above in the seventh embodiment, the entire image of the frame image is formed of output image signals of individual light receiving pixels arranged in the effective pixel region of the image sensor 33 (see FIGS. 18 and 19). Therefore, in the case where a moving image is taken, when a size of the clipping frame is changed by the increasing operation or the decreasing operation, it is possible to define the clipping frame (clipping region) after the change on the image sensor 33 and to read only the output image signal of the light receiving pixels inside the clipping frame from the image sensor 33. Here, the image formed of the read image signal is equivalent or the clipped image described above, and this image may be displayed as the output image on the camera monitor 17 (or the TV monitor 7) and recorded in the recording medium 15.

According to this embodiment, not only the decrease of an angle of view of the display image and the record image but also the increase of the angle of view of the display image and the record image can be instructed by the intuitive touch panel operation.

### Eleventh Embodiment

The eleventh embodiment of the present invention will be described. The eleventh embodiment is an embodiment based on the description in the eighth embodiment, and as to matters that are not particularly described in this embodiment, the description in the eighth embodiment is also applied to this embodiment as long as no contradiction arises. Therefore, similarly to the eighth embodiment, the following description in the eleventh embodiment is an operational description of the digital camera 1 in the imaging mode. The matters described in the ninth embodiment can be applied to the eighth embodiment. The eleventh embodiment corresponds to a combination of the eighth and the ninth embodiments.

As described above in the eighth embodiment, an imaging angle of view and an incident position on the image sensor 33 can be adjusted by the touch panel operation according to the method Aᵢ. The adjustment of an imaging angle of view described above in the eighth embodiment corresponding to the decrease of the imaging angle of view. The user can perform an imaging view angle decrease instruction operation and an imaging view angle increase instruction operation by using the touch panel. Each of the imaging view angle decrease instruction operation and the imaging view angle increase instruction operation is one type of the touch panel operation. The touch panel operation for decreasing an imaging angle of view described above in the eighth embodiment corresponds to the imaging view angle decrease instruction operation.

The method of the imaging view angle decrease instruction operation is similar to the decreasing operation for decreasing a size of the clipping frame described above in the ninth embodiment, and the method of the imaging view angle increase instruction operation is similar to the increasing operation for increasing a size of the clipping frame described above in the ninth embodiment. When the matter described above in the ninth embodiment is applied to this embodiment, the clipping frame (or size of the clipping frame) in the ninth embodiment should be read as “imaging angle of view”, and the changing rate in the ninth embodiment should be read as “imaging angle of view changing rate”. The imaging angle of view changing rate is expressed by “ANG_{AF}/ANG_{BF}”, for example. ANG_{BF} represents an imaging angle of view before the imaging angle of view is changed, and ANG_{AF} represents an imaging angle of view after the imaging angle of view is changed.

When the imaging view angle decrease instruction operation is performed, an imaging angle of view changing rate is determined in accordance with the method described above in the ninth embodiment, and the photography control unit 13 illustrated in FIG. 1 decreased the imaging angle of view in accordance with the determined imaging angle of view changing rate. When the frame image 500 illustrated in FIG. 20A is displayed, if the imaging view angle decrease instruction operation is performed, after the imaging angle of view is decreased, for example, the frame image 510 illustrated in FIG. 20B is taken by photography so as to be displayed and recorded.

When the imaging view angle increase instruction operation is performed, the imaging angle of view changing rate is determined in accordance with the method described above in the ninth embodiment, and the photography control unit 13 illustrated in FIG. 1 increases the imaging angle of view in accordance with the determined imaging angle of view changing rate. When the frame image 510 illustrated in FIG. 20B is displayed, if the imaging view angle increase instruction operation is performed, after the imaging angle of view is increased, for example, the frame image 500 illustrated in FIG. 20A is taken by photography so as to be displayed and recorded.

According to this embodiment, not only the decrease of the angle of view of the display image and the record image but also the increase of the angle of view of the display image and the record image can be instructed by an intuitive touch panel operation.

<<Variations>>

Specific numerical values indicated in the above description are merely examples, and they can be changed to various values as a matter of course. As variations or annotations of the embodiments described above, Note 1 and Note 2 are described below. Descriptions in the Notes can be combined in any way as long as no contradiction arises.

[Note 1]

In each embodiment described above, the touch panel is used as an example of a pointing device for specifying a position and a size of the clipping frame and the expansion specifying frame. However, it is possible to use a pointing device other than the touch panel (e.g., a pen tablet or a mouse) so as to specify a position and a size of the clipping frame and the expansion specifying frame.

[Note 2]

The digital camera 1 according to the embodiments can be constituted of hardware or a combination of hardware and software. If software is used for constituting the digital camera 1, a block diagram of a portion realized by software indicates a functional block diagram of the portion. The function realized by using software may be described as a program, and the program may be executed by a program execution device (e.g., a computer) so as to realize the function.

What is claimed is:

1. An image reproducing apparatus comprising a touch panel monitor which has a display screen and receives touch panel operation performed with an operation member touching the display screen, in which an output image obtained by extracting an image inside an extraction region as a part of an entire image area of an input image from the input image is displayed on the touch panel monitor or a monitor of an external display device, wherein
the touch panel monitor receives region specifying operation of specifying a position and a size of the extraction region as one type of the touch panel operation when an entire image of the input image is displayed on the display screen, and
in the region specifying operation, the position and the size of the extraction region are specified
on the basis of a position at which the operation member touches the display screen and a period of time while the operation member is touching the display screen, or
on the basis of an initial point and a terminal point of a movement locus of the operation member on the display screen, or
on the basis of a plurality of positions at which a plurality of operation members as the operation member touch the display screen.

2. An image reproducing apparatus according to claim 1, wherein the touch panel operation includes increasing operation of instructing an increase of the size of the extraction region and decreasing operation of instructing a decrease of the size of the extraction region.

3. An image reproducing apparatus according to claim 1, wherein when the region specifying operation is performed, contents specified by the region specifying operation are reflected promptly or step by step on display contents of the touch panel monitor.

4. An image reproducing apparatus according to claim 1, wherein
the input image and the output image are moving images,
the moving image as the output image is displayed on the touch panel monitor or the monitor of the external display device, so that reproduction of the moving image as the output image is performed, and
the image reproducing apparatus temporarily stops the reproduction during a period while the region specifying operation is received.

5. An image reproducing apparatus according to claim 2, wherein a notification is made about which one of the increasing operation and the decreasing operation the touch panel operation corresponds to.

6. An image sensing apparatus comprising the image reproducing apparatus according to claim 1, wherein an input image supplied to the image reproducing apparatus is obtained by photography.

7. An image sensing apparatus comprising:
a touch panel monitor which has a display screen and receives touch panel operation performed with an operation member touching the display screen;
an image sensor which outputs an image signal indicating an incident optical image of a subject; and
an extracting unit which extracts an image signal inside an extraction region as a part of an effective pixel region of the image sensor, wherein
the touch panel monitor receives region specifying operation of specifying a position and a size of the extraction region as one type of the touch panel operation when the an entire image based on the image signal inside the effective pixel region is displayed on the display screen, and
in the region specifying operation, the position and the size of the extraction region are specified
on the basis of a position at which the operation member touches the display screen and a period of time while the operation member is touching the display screen, or
on the basis of an initial point and a terminal point of a movement locus of the operation member on the display screen, or
on the basis of a plurality of positions at which a plurality of operation members as the operation member touch the display screen.

8. An image sensing apparatus according to claim 7, wherein the touch panel operation includes increasing operation of instructing an increase of the size of the extraction region and decreasing operation of instructing a decrease of the size of the extraction region.

9. An image sensing apparatus comprising:
a touch panel monitor which has a display screen and receives touch panel operations performed with an operation member touching the display screen;
an image pickup unit which has an image sensor to output an image signal indicating an incident optical image of a subject and generates an image by photography from an output signal of the image sensor;
a view angle adjustment unit which adjusts an imaging angle of view in the image pickup unit; and
an incident position adjustment unit which adjusts an incident position of the optical image on the image sensor, wherein
the touch panel monitor receives view angle and position specifying operation for specifying the imaging angle of view and the incident position as one type of the touch panel operation when a taken image obtained by the image pickup unit is displayed on the display screen, and
in the view angle and position specifying operation, the imaging angle of view and the incident position are specified
on the basis of a position at which the operation member touches the display screen and a period of time while the operation member is touching the display screen, or
on the basis of an initial point and a terminal point of a movement locus of the operation member on the display screen, or
on the basis of a plurality of positions at which a plurality of operation members as the operation member touch the display screen.

10. An image sensing apparatus according to claim 9, wherein the touch panel operation includes increasing operation of instructing an increase of the imaging angle of view and decreasing operation instructing a decrease of the imaging angle of view.

11. An image sensing apparatus comprising:
an image pickup unit which has an image sensor to output an image signal indicating an incident optical image of a subject and generates an image by photography from an output signal of the image sensor;
a view angle adjustment unit which adjusts an imaging angle of view in the image pickup unit; and
an incident position adjustment unit which adjusts an incident position of the optical image on the image sensor, wherein
view angle and position specifying operation for specifying the imaging angle of view and the incident position is received as single operation.

12. An image sensing apparatus according to claim 11, further comprising a touch panel monitor having a display screen, wherein
the view angle and position specifying operation is performed by touching the display screen with the operation member when a taken image obtained before the view angle and position specifying operation is performed is displayed on the display screen, and
the view angle and position specifying operation is performed without the step that the operation member is released from the display screen.
